(19) United States
(12) Patent Application Publication
(10) Pub. No.: US 2025/0263307 A1
(43) Pub. Date: Aug. 21, 2025

(54) METHODS FOR PREPARING LITHIUM NICKEL MANGANESE COBALT OXIDE PARTICULATE

(71) Applicant: Novonix Battery Technology Solutions Inc., Dartmouth (CA)

(72) Inventors: Lituo Zheng, Halifax (CA); Mark Nikolas Obrovac, Halifax (CA); Mohammad Hossein Tahmasebi Sefid Dashti, Halifax (CA); Laurie Carrier, Halifax (CA); Ido Ben Barak, Lower Sackville (CA)

(21) Appl. No.: 18/867,360

(22) PCT Filed: May 24, 2023
(86) PCT No.: PCT/US2023/067437

§ 371 Date: Nov. 19, 2024

Related U.S. Application Data
(60) Provisional application No. 63/346,430, filed on May 27, 2022.

(51) Int. Cl. C01G 53/504; H01M 4/525

(52) U.S. Cl. CPC C01G 53/504; H01M 4/525; C01P 2002/32; C01P 2002/50; C01P 2002/60; C01P 2002/74; C01P 2004/03; C01P 2004/50; C01P 2004/61; C01P 2006/40

(57) ABSTRACT

Improved methods for preparing lithium nickel manganese cobalt oxide particulate are disclosed for use in lithium batteries and other applications. The methods involve triturating and heating steps that produce single-phase rock-salt precursor particulate from which the lithium nickel manganese cobalt oxide particulate can be readily prepared. Advantageously, the triturating step can involve dry, lower energy procedures that take less time to prepare precursor particulate than previous methods. The methods therefore can be simpler, faster, and can reduce contamination in the product. Also disclosed is the optional use of novel biphasic precursor particulate in the preparation methods.

### TECHNICAL FIELD

Embodiments disclosed herein pertain to improved methods for preparing lithium nickel manganese cobalt oxide particulate. The prepared lithium nickel manganese cobalt oxide particulate is useful as an electrode material in lithium batteries and other applications.

### BACKGROUND

The development of rechargeable high energy density batteries, such as Li-ion batteries, is of great technological importance. Typically, commercial rechargeable Li-ion batteries use a lithium transition metal oxide cathode and a graphite anode. While batteries based on such materials are approaching their theoretical energy density limit, significant research and development continues in order to improve other important characteristics such as cycle life, efficiency, and cost. Further, significant research and development continues in order to simplify the methods of production and to reduce the complexity, material amounts, and losses involved.

Insertion compound transition metal oxide cathode materials for use in lithium rechargeable batteries typically comprise lithium, one or more Ni, Mn or Co, oxygen, and optional metal dopants (e.g. Mg, Al, Ti, Zr, W, Zn, Mo, K, Na, Si, Ta) and such materials can be further coated with other materials (e.g. Al₂O₃, ZrO₂, TiO₂). For ease of manufacturing, an air stable version of the transition metal oxide is usually employed. Given the substantial demand for these batteries, it is of great importance to be able to provide significant and economic supplies of such materials. At present, lithium nickel manganese cobalt oxide particulate (LiNMC), known as “NMC” commercially, are preferred cathode materials for commercial Li-ion batteries.

“NMC” type materials for use as cathodes in Li-ion batteries may have an O3 layered structure and have the general actual formula Li₁₊ₓ[(NiₙMnₘCo_{c})₁₋ₐAₐ]₁₋ₓO₂, where −0.03≤x≤0.06; n+m+c=1; n ≥0.05; m≥0.05; c≥0.05; A is a metal dopant; and 0≤a≤0.05. Especially desirable in some applications are single crystal LiNMC lithium transition metal oxide particulate materials, abbreviated as SC-LiNMC and also known as monolithic “NMC”, in which the average LiNMC grain size exceeds 1 μm. In some embodiments, SC-LiNMC particles can consist of multiple LiNMC grains. In preferred embodiments, SC-LiNMC particles can each consist of a single LiNMC grain. In some embodiments, SC-LiNMC particles can each consist of multiple LiNMC grains, where the average “NMC” grain size is greater than 20% of the average particle size. In some embodiments of SC-LiNMC, the average grain size (D50) is between 1 μm and 20 μm.

A method of preparing LiNMC (including SC-LiNMC) is to first make a mixed metal hydroxide (MMH) precursor particulate or a mixed metal carbonate (MMC) precursor particulate of Ni, Mn, Co, and optional metal dopant A, each in proportion according to the desired final LiNMC composition. The MMH or MMC precursor particulate is made by co-precipitation of metal salts in an aqueous solution, followed by filtering, drying and grinding steps. The resulting MMH or MMC precursor particulate is then ground together with a lithium source (e.g. LiOH, LiOH·H₂O or Li₂CO₃), typically in an amount that is in excess of the desired LiNMC composition to form a mixture. The mixture is then sintered in air at temperatures in the range of 600-1000° C. A description of the synthesis of LiNMC by this method can be found in Journal of The Electrochemical Society. 165 (5) A1038-A1045 (2018). A two-step heating method can also be employed, as described in WO 2019/185349. The co-precipitation method may be used because it produces MMH or MMC precursor particulate that have a particle size larger than 100 nm. Smaller particle sizes create problems with dust and particle handling, making processing more costly. In addition, the co-precipitation method may be used because it achieves atomic-scale mixing of the transition metals in the MMH or MMC. Atomic-scale mixing is desirable, since the transition metals can diffuse slowly during sintering, resulting in the formation of unwanted impurity phases in the LiNMC formed after sintering. Therefore, if atomic mixing is not achieved in the MMH or MMC, then long sintering times may be required to convert the MMH or MMC precursor particulates to the desired single-phase LiNMC, which can increase cost. Lithium loss via evaporation also commonly occurs during the sintering step, making long sintering times undesirable. Co-precipitation methods also require many steps and can produce large amounts of wastewater. In addition, the co-precipitation method requires that the sources of transition metals are soluble metal salts, which can be more expensive than insoluble sources of these metals, such as metal oxide, hydroxide and carbonate compounds.

A method for making “NMC” is described in U.S. Pat. No. 7,211,237, in which cobalt-, manganese-, nickel-, and lithium containing oxides or oxide precursors are wet milled together to form a precursor. The precursor is then heated to produce an “NMC”. This method also has the disadvantage of using water, which needs to be removed by drying prior to or during the heating step.

The Journal of The Electrochemical Society, 159 (9) A1543-A1550 (2012) describes a method in which SC-Li_{1+0.14}(Ni_{0.33}Mn_{0.33}Co_{0.33})_{0.86}O₂ is made by ball milling Ni(NO₃)₂·6H₂O, Mn(NO₃)₂·4H₂O and Co(NO₃)₂·6H₂O together, adding LiNO₃ and LiCl, and then heating. In this method the LiCl and KCl components are present to form a molten salt, which requires removal by rinsing after the heating step to obtain the SC LiNMC particles. This method requires many steps and can produce large amounts of wastewater.

As stated in Linden's Handbook of Batteries, 4th Edition, McGraw-Hill Education (2010): “NMC and NCA materials rely on a uniform and homogeneous distribution of cations in the transition metal layers of the structure. The most common way to ensure this is to use a mixed transition metal hydroxide or carbonate precursor that has the cations perfectly mixed on the atomic scale.” A useful way to synthesize such precursors is by co-precipitation. Solid-state reactions have also been proposed as an economical method to make “NMC” lithium transition metal oxide particulate materials, in which precursors are ground and sintered without the co-precipitation step. However, solid state reactions typically result in inhomogeneous element distribution and low particle size in the lithium transition metal oxide particulate, both of which are detrimental to electrochemical performance. Therefore, solid-state synthesis methods are generally thought to be unsuitable as a practical synthesis method for “NMC”. For instance, regarding the solid-state synthesis of “NMC” the following two quotations are of note:

Nano Energy, 31 247-257 (2017): “Comparing to co-precipitation process, solid-state synthesis is expected to have a reduced cost, and reduced synthesis time. However, the major disadvantage of the solid-state synthesis is the difficulty in controlling the segregation of transition metal elements in the primary particle level, which in turn has significant impact on the electrochemical performance of the final cathode materials.”

Chemistry of Materials, 29 9923-9936 (2017): “Li-rich layered compounds with different morphologies can be prepared via a wide variety of synthesis pathways including solid state, molten salts, hydrothermal, and sol-gel as well as coprecipitation in aqueous medium followed by high temperature synthesis. Among the various possible techniques, solution based coprecipitation (or aqueous sol-gel) is more viable as it can provide atomic level mixing of transition metal ions and hence homogeneity in the final oxide.”

In U.S. provisional applications 62/893,787 and 62/946,938 filed on Aug. 29, 2019 and Dec. 11, 2019 respectively, both by the same applicant and both titled “Improved Microgranulation Methods And Product Particles Therefrom”, certain NMC precursor particles were disclosed in the examples that had been prepared using an all-solid-state method. The content of these two US provisional applications are incorporated by reference herein in their entirety.

The Journal of The Electrochemical Society, (167) 050501 (2020) describes a method in which acetate transition metal salts were used to prepare a Ni_{0.25}Mn_{0.25}CO_{0.5}O precursor particulate via a colloidal synthetic method. The resulting Ni_{0.25}Mn_{0.25}Co_{0.5}O precursor particulate was nanocrystalline and had a single-phase rock-salt structure. Precursor particulates with a single-phase rock-salt structure are desirable for the synthesis of LiNMC, since they contain transition metals in an atomically mixed solid solution. However, the synthesis described in this reference includes the use of solvents. The resulting precursor particulate formed by the method had broad XRD diffraction peaks, which can be indicative of composition variation from particle to particle or within the particles themselves.

U.S. Pat. No. 10,651,467 B2 describes a method in which precursors are synthesized for the preparation of spinel phase Li—Ni—Mn—O. The preparation of the precursor includes ball milling starting materials, followed by heating under a reducing atmosphere. The resulting precursor may include a rock-salt phase. The starting materials include metal oxides, nitrates, sulfates and hydroxides in which the metals have various oxidation states with no limitation or guidance relating to which oxidation states or combination of oxidation states are to be used for the preparation of precursors. The precursors described include multiphase precursors that are not atomically mixed, which, as mentioned above, is detrimental for the formation of single-phase cathode materials.

Layered hydroxide phases may be utilized as precursors from which LiNMC cathodes are made. LiNMC cathodes are formed from transition metal hydroxide precursors (e.g. a Ni, Mn, Co hydroxide) by combining the precursor with a lithium source and heating in air at temperatures above 700° C. Exemplary cathodes are made at temperatures above 800° C. Single crystal LiNMC (SC-LiNMC) may be made when hydroxide precursors are heated with a lithium source above 900° C. in air. Often an excess of the lithium source (up to 20% excess) can be used to enhance grain growth and to make up for lost lithium during the heating step. Hydroxide precursors made via the co-precipitation process are preferred, since they incorporate atomic-scale mixing of the transition metals. Hydroxide precursors are further used because of facile lithium diffusion into their structure, allowing rapid NMC formation during heating with a lithium source. Lithium sources that may be used with hydroxide precursors include Li₂CO₃ and LiOH·H₂O.

Although dry processing techniques for the production of layered lithium transition metal oxide cathode materials can lead to considerable cost savings, higher compositional flexibility in the final product, and the reduction of waste, typical dry processing steps, such as ball milling, can lead to contamination from the milling media and from the milling container itself. This contamination is typically in the form of iron contamination, which is known to lead to capacity fade in layered lithium transition metal oxide cathode material compositions such as LiNMC or LiNCA, due to the tendency for Fe to reside in the lithium layer. For this reason, very little iron contamination can be tolerated in these materials. Typically, commercial LiNMC materials are limited to Fe contents of less than 100 ppm, based on the total metal content. Therefore, methods based primarily on thermal processing, in which both wet and dry processing methods are minimized or even eliminated, are even more advantageous. Thermal processing methods can be less costly than methods involving wet processing or even dry processing techniques. In addition, thermal processing produces little or no waste and introduces little or no impurities.

A major impediment to using primarily dry processing techniques is the difficulty in obtaining phase-pure mixed transition metal oxide particulate with a distribution of transition metals that is homogeneous within each particle and from particle to particle. This is due to the slow diffusion of the transition metals during thermal processing. For this reason, precursors in which the transition metals are already atomically mixed are typically prepared prior to thermal processing. For instance, lithium mixed transition metal layered oxide cathode materials, such as LiNMC and LiNCA, are typically prepared by the thermal processing of a mixture of a lithium source (e.g., lithium carbonate or lithium hydroxide) with a precursor transition metal hydroxide made by co-precipitation in which the transition metals are atomically mixed. In published PCT application WO2021/041296, a method is described for creating a precursor particulate consisting essentially of a single rock-salt phase having the formula (NiₙMnₘCo_{c})₁₋ₐAₐLi_{b}O_{1+b} having a grain size less than 50 nm. This precursor phase is made by dry impact milling. Its low grain size facilitates lithiation during thermal processing to form LiNMC. However, the dry impact milling process may introduce impurities due to wear of the milling chamber and milling media.

Despite this continuing and substantial global effort directed at developing improved methods of manufacture of such materials, there remain a need for further improvement. Embodiments of the present invention address these needs and provide further benefits as disclosed below.

### Summary

The present disclosure relates to improved methods for preparing lithium nickel manganese cobalt oxide particulate for use in lithium batteries and other applications. In the methods, single-phase rock-salt precursor particulate is initially prepared using triturating and heating steps. Advantageously though, the triturating step can be accomplished much faster while using dry, lower energy trituration procedures than methods of the prior art. Thereafter, lithium nickel manganese cobalt oxide particulate can be readily prepared from the precursor particulate. The methods therefore can be simpler, faster, and can reduce contamination in the product. The embodiments herein also involve the optional use of novel biphasic precursor particulate in the preparation methods.

The method relates to preparing a lithium nickel manganese cobalt oxide particulate having the formula Li₁₊ₓ[(NiₙMnₘCo_{c})₁₋ₐAₐ]₁₋ₓO₂, in which−0.03≤x≤0.06; n+m+c=1; n≥0.05; m≥0.05; c≥0.05; A is a metal dopant; and 0≤a≤0.05. For instance, as shown in the Examples below, particulate in which n, m, and c are about 0.6, about 0.2 and about 0.2 respectively can be prepared. The method may comprise the steps of:
a) providing feedstock component particulate with an Ni:Mn:Co molar ratio of n:m:c comprising a nickel containing particulate, a manganese containing particulate, a cobalt containing particulate, and an optional dopant A containing particulate;
b) triturating the feedstock component particulate to form a homogenous feedstock particulate mixture;
c) heating the homogenous feedstock particulate mixture from b) at a temperature of greater than about 500° C. for a set time of at least about 1 hour, thereby producing a precursor particulate having a rock-salt structure and the formula (NiₙMnₘCo_{c})₁₋ₐAₐO;
d) combining an amount of the precursor particulate with an amount of a lithium source to produce a precursor particulate lithium source mixture wherein the amount of the lithium source is greater than or equal to the stoichiometric amount required to make the lithium nickel manganese cobalt oxide particulate; and
e) heating the precursor particulate lithium source mixture from d) in an oxygen containing atmosphere at a lithiating temperature to produce the lithium nickel manganese cobalt oxide particulate.

In step a) of the method, the feedstock component particulate may also comprise a flux, which may enhance the diffusion of transition metals during step c), resulting in greater compositional homogeneity. Suitable fluxes are materials that are molten during the heating step c), are materials in which oxides of nickel, manganese, and cobalt have some solubility, and are materials whose components do not incorporate into the rock-salt phase of the precursor particulate (other than oxygen). Examples of suitable fluxes include alkali metal sulfate salts, such as Li₂SO₄, Na₂SO₄, K₂SO₄ and combinations thereof; B₂O₃, WO₃, BiO₂, and MoO₃. In some embodiments, salts which additionally are soluble in water can be particularly useful, since such fluxes may be removed by washing with water after the heating step c).

In some aspects, step b) of the method, the feedstock triturating procedure may comprise the steps of selecting a feedstock triturating apparatus and a process for the feedstock triturating apparatus, and then triturating the feedstock component particulate using the feedstock triturating apparatus and process for the feedstock triturating apparatus for a feedstock triturating time. In some aspects, a feedstock triturating procedure produces a multiple-phase feedstock particulate mixture which still consists essentially of the nickel containing particulate phase, the manganese containing particulate phase, the cobalt containing particulate phase, and the optional dopant A containing particulate phase in a homogeneous mixture. That is, the multiple particulates in the feedstock particulate mixture will not have been triturated to such an extent that they react chemically to any significant amount. The presence of the multiple phases can readily be confirmed by x-ray diffraction analysis.

In some aspects, triturating the feedstock component particulates to form a homogenous feedstock particulate mixture comprises triturating the feedstock component particulates for an amount of time determined by: obtaining samples from the feedstock component particulates at one or more time intervals during the triturating step; heating the samples; determining the structure of the heated samples via x-ray diffraction analysis; and determining the feedstock triturating time based on the time interval that results in heated sample having a single-phase rock-salt structure with an apparent lattice strain of less than about 0.3%. In some aspects, the time intervals may be several time intervals.

In some aspects in step c) of the method, the heating procedure comprises the simple step of heating the homogeneous feedstock particulate mixture from step b) to a set temperature for a set time under a suitable heating atmosphere, thereby producing a precursor particulate having a rock-salt structure and the formula (NiₙMnₘCo_{c})₁₋ₐAₐO where n, m, c, a are positive numbers, A is a metal dopant, and n+m +c=1; n>0.05; m≥0.05; c≥0.05; and 0≤a≤0.05. In some aspects an example of a suitable representative heating procedure is to heat the homogeneous feedstock particulate mixture for 12 hours at 1000° C. under an argon flow.

In some aspects in the preparation of the final lithium nickel manganese cobalt oxide particulate product, the amount of the lithium source employed in step d) is greater than or equal to the stoichiometric amount required to make the lithium nickel manganese cobalt oxide particulate;

In some aspects, in step b) of the method, the feedstock triturating time may be a function of the particulates used, the feedstock triturating apparatus used, and the process for the feedstock triturating apparatus employed. The triturating time may be determined empirically either by a direct method or procedure or an indirect method or procedure. A direct procedure may comprise the steps of: obtaining one or more samples from time to time from the triturating feedstock component particulate in b) during the feedstock triturating procedure, heating the samples according to a representative rock-salt heating procedure, determining the structure of the heated samples via x-ray diffraction analysis, and continuing the triturating in b) until a heated sample is determined to have a structure corresponding to a rock-salt precursor particulate having the formula (NiₙMnₘCo_{c})₁₋ₐAₐO with an apparent lattice strain of less than 0.3%, thereby determining the feedstock triturating time. In other words, the direct method involves determining the appropriate feedstock triturating time while the triturating is in progress. An indirect procedure may involve predetermining an appropriate feedstock triturating time.

For instance, a suitable indirect procedure for determining a feedstock triturating time can comprise the steps of: preparing one or more representative sample mixtures of the nickel containing particulate, the manganese containing particulate, and the cobalt containing particulate, triturating the one or more representative sample mixtures using a representative triturating apparatus and representative process for the representative triturating apparatus for different periods of time, heating the representative sample mixtures according to a representative heating procedure, determining the structure of the heated representative sample mixtures via x-ray diffraction analysis, and determining the feedstock triturating time based on which triturating time periods result in heated representative sample mixtures having a single-phase rock-salt structure with an apparent lattice strain of less than 0.3%. An appropriate feedstock triturating time would be one that was used successfully in the past under similar circumstances. In some embodiments the direct method may be forgone or replaced with an indirect method, such as predetermining the trituration time with the indirect method. In some embodiments the indirect method may be performed on a smaller scale or in smaller batches than the direct method. For example, the indirect method may comprise preparing the one or more representative sample mixtures, triturating the one or more representative sample mixtures, heating the representative sample mixtures, and determining the structure of the heated representative sample but the indirect method would be performed in a smaller scale, such as a test batch or a trial batch.

In some aspects of the method disclosed herein, the nickel containing particulate, the manganese containing particulate, and the cobalt containing particulate can be selected from the group consisting of metal oxides, metal hydroxides, metal carbonates and mixtures thereof. In some aspects, these particulates can be NiO, MnO, and CoO respectively, all of which start with the desired rock-salt structure. In some aspects, n, m, and c are about 0.6, about 0.2 and about 0.2 respectively.

In embodiments comprising amounts of a dopant A, the feedstock component particulate additionally may comprise an amount of dopant A containing particulate. Possible dopants include Mg, Al, Ti, Zr, W, Zn, Fe, Mo, K, Na, Si, Ta, and mixtures thereof. Suitable dopant A containing particulate may be selected from the group consisting of metal oxides, metal hydroxides, metal carbonates and mixtures thereof. In particular, dopant A containing particulates can be MgO, Al₂O₃, TiO, TiO₂, ZrO₂, WO₃, ZnO, FeO, Fe₂O₃, Fe₃O₄, MoO₃, K₂O, Na₂O, SiO₂, Ta₂O₅, Mg(OH)₂, Al(OH)₃, AlO(OH), Zr(OH)₄, Zn(OH)₂, Fe(OH)₂, FeO(OH), Fe(OH)₃, KOH, and NaOH.

In some embodiments, feedstock component precursor particulate can comprise metal oxides, metal hydroxides, metal carbonates with more than one metal element, such as MgAl₂O₄, MgMn₂O₄, CoAl₂O₄, NiCoO₂, etc. In some embodiments, feedstock component precursor particulate can include waters of hydration.

In some aspects, the feedstock triturating apparatus used in step b) can be for either a “wet” or “dry” triturating process. Desirably however, a dry process is used and the feedstock triturating apparatus is a dry grinding apparatus. Such apparatus may include an autogrinder or mortar and pestle as used in Examples disclosed herein. However for commercial purposes, larger scale apparatus for jet milling, ball milling, bead milling, small media milling, agitator ball milling, planetary milling, horizontal ball milling, pebble milling, rod milling, attritor milling, pulverizing, hammer milling, and the like would be more suitable and advantageously lower the costs of production.

In some aspects, the triturating produces the homogeneous feedstock particulate mixture consisting essentially of the nickel containing particulate phase, the manganese containing particulate phase, the cobalt containing particulate phase, and the optional dopant A containing particulate phase; and wherein no chemical reaction occurs between the nickel containing particulate phase, the manganese containing particulate phase, the cobalt containing particulate phase, and the optional dopant A containing particulate phase during triturating step b).

Depending on the feedstock triturating procedure, suitable feedstock triturating times in step b) can be in the range from about 10 minutes to about 6 days or more. Further, suitable set temperatures in step c) or in a heating step following trituration can be in the range from about 500 to about 1600° C. And a suitable set time in step c) can be about 1 hour to about 12 hours. Further still, a suitable heating atmosphere in the rock-salt forming heating procedure of step c) can be an inert gas (e.g. argon or nitrogen gas), or a vacuum, or a reduced oxygen partial pressure gas (i.e. a gas whose equilibrium oxygen partial pressure at a given temperature is less than the partial pressure of oxygen in air, e.g. CO₂).

In another aspect, the method can additionally comprise: before step c), forming the homogeneous feedstock particulate mixture into a pellet. This may be accomplished with a pellet die and a press or a pelletizing machine. Forming the homogeneous feedstock particulate mixture can enhance solid state diffusion during step c), resulting in improved compositional homogeneity in the as-formed precursor particulate.

In another aspect, the method can additionally comprise: before step d), washing the precursor particulate with water to remove a flux. This washing step may include the steps of mixing the precursor particulate with water to dissolve the flux and then separating the precursor particulate from the water/flux solution. Suitable methods of separating the precursor particulate from the water/flux solution can include filtering or centrifuging. In some embodiments in which feedstock component particulate comprises a flux, it may be advantageous not to include a washing step before step d). In such embodiments, the presence of the flux may aid in the formation of the lithium nickel manganese cobalt oxide particulate during step e).

In another aspect, the x-ray diffraction analysis determines the homogeneity of the trituration mixture. In another aspect, the method additionally comprises forming the precursor particulate lithium source mixture into a pellet prior to step e). In another aspect, the method additionally comprises adding a flux to the precursor particulate lithium source mixture prior to step e). In another aspect, the method additionally comprises adding a flux to the feedstock component particulate of step a).

In some embodiments, for lithiating purposes, the lithium source used can be lithium carbonate, lithium hydroxide or lithium oxide or mixtures thereof and the amount used can be between about 0 to 30% greater than the stoichiometric amount required to make the lithium nickel manganese cobalt oxide particulate. In some aspects, the oxygen containing atmosphere in e) is air or oxygen. Further, the oxygen containing atmosphere employed in step e) can be air or pure oxygen and the lithiating temperature used in step e) can be in the range from about 700 to 1000° C. Further still, the heating in step e) can be performed for about 9 hours.

In some aspects, the method can optionally include a step of determining the structure of the obtained samples via x-ray diffraction analysis before heating the obtained samples in order to ensure the obtained samples consist essentially of the nickel containing particulate phase, the manganese containing particulate phase, the cobalt containing particulate phase, and the optional dopant A containing particulate phase.

In another aspect, the method can additionally comprise: before step e), forming the precursor particulate lithium source mixture into a pellet. This may be accomplished with a pellet die and a press or a pelletizing machine. Forming the precursor particulate lithium source mixture into a pellet can reduce lithium loss during the heating step e) as opposed to heating the precursor particulate lithium source mixture as a loose powder. Forming the precursor particulate lithium source mixture into a pellet can also enhance solid state diffusion, resulting in improved compositional homogeneity in the LiNMC product.

In another aspect, the method can additionally comprise: before step e), adding a flux to the precursor particulate lithium source mixture pellet. The presence of the flux may aid in the formation of the lithium nickel manganese cobalt oxide particulate during step e). Suitable fluxes are materials that are molten during the heating step e), are materials in which oxides of nickel, manganese, and cobalt have some solubility, and are materials whose components do not incorporate into the NMC structure (other than lithium and oxygen). Examples of suitable fluxes include alkali metal sulfate salts, such as Li₂SO₄, Na₂SO₄, K₂SO₄ and combinations thereof; B₂O₃, WO₃, BiO₂, and MoO₃. In some embodiments, salts which additionally are soluble in water can be particularly useful, since such fluxes may be removed by washing with water after the heating step c).

In another aspect, the method can additionally comprise: before step d), heating the precursor particulate in an oxygen containing atmosphere to change the precursor particulate from a particulate having a rock-salt structure to a biphasic particulate consisting essentially of a rock-salt phase and a cubic spinel phase. Suitable oxygen containing atmospheres include oxygen, air or dry air. In particular, this biphasic precursor particulate essentially contains no tetragonal spinel phase.

As disclosed above, the feedstock triturating time is determined such that the apparent lattice strain of the single-phase rock-salt precursor particulate in c) is less than 0.3%. In exemplary embodiments, the feedstock triturating time may also be determined such that the apparent lattice strain of the single-phase rock-salt precursor particulate in c) is less than 0.2%, less than 0.1% or even smaller.

In some embodiments, small amounts of an additional phase may also be present in the precursor particulate in certain embodiments. For instance, the heated precursor particulate from step c) may additionally comprise a metallic phase.

With regards to certain physical characteristics of the materials involved, the precursor particulate may have an average grain size greater than 100 Å (as determined by applying the Scherrer equation to the largest x-ray diffraction peak of the particulate). In some instances, grain sizes that are even greater than can be measured by common laboratory x-ray diffractometers are possible (e.g. greater than 100 nm, greater than 500 nm or even greater than 1 μm). In such cases, grain sizes can be determined by direct observation of faceted crystallites by secondary electron microscopy. In a like manner involving the novel biphasic precursor particulate, each of the rock-salt phase and the spinel phase present may have average grain sizes greater than 100 Å, greater than 200 Å, greater then 100 nm, greater than 500 nm or even greater than 1 μm.

In a related aspect, the novel biphasic particulate has the composition (NiₙMnₘCo_{c})₁₋ₐAₐO_{1+b} where n, m, c, a are positive numbers, A is a metal dopant, and n+m+c=1; n≥0.05; m≥0.05; c≥0.05; 0≤a≤0.05; and 0<b<0.33 and further consists essentially of a rock-salt phase and a cubic spinel phase. In some embodiments b is about (m+c)/3. In some aspects, the rock-salt phase can be NiO while the cubic spinel phase can have the chemical formula M₃O₄ in which M is a mixture of Mn and Co. Further, M can additionally comprise Ni. Further still, the cubic spinel phase can have a lattice constant in the range of 8.1 Å to 8.4 Å.

In some aspects the disclosure relates to a product of a particulate having a composition (NiₙMnₘCo_{c})₁₋ₐAₐO where n, m, c, a are positive numbers, A is a metal dopant, and n+m+c=1; n≥0.05; m≥0.05; c≥0.05; and 0≤a≤0.05; consisting essentially of a rock-salt phase; and having an apparent lattice strain that is less than 0.3%.

The lithium transition metal oxide particulate made according to the methods herein may be considered for use in numerous commercial applications including as a rechargeable battery electrode component. It can be particularly suitable for use in cathode electrodes in rechargeable lithium batteries, e.g. lithium ion batteries.

### BRIEF DESCRIPTION OF THE DRAWINGS

FIG. 1 shows the XRD pattern of NiO feedstock component particulate.

FIG. 2 shows the XRD pattern of MnO feedstock component particulate.

FIG. 3 shows the XRD pattern of CoO feedstock component particulate.

FIGS. 4a and b show SEM images of NiO feedstock component particulate.

FIGS. 5a and b show SEM images of MnO feedstock component particulate.

FIGS. 6a and b show SEM images of CoO feedstock component particulate.

FIG. 7 shows XRD patterns of the RS-precursor particulate of Comparative Examples 1-3 and Examples 1 and 2.

FIG. 8 shows the XRD pattern of the feedstock particulate mixture of Example 1.

FIG. 9 shows the XRD pattern of the feedstock particulate mixture of Example 2.

FIGS. 10a and b show SEM images of the feedstock particulate mixture of Example 1 at different magnifications.

FIGS. 11a and b show SEM images of the feedstock particulate mixture of Example 2 at different magnifications.

FIG. 12 shows the apparent lattice strain as a function of the autogrinding time used to prepare the RS-precursor particulates of Comparative Examples 1-3 and Examples 1 and 2.

FIG. 13 shows the XRD pattern of the RS-precursor particulate of Example 3.

FIG. 14 shows the XRD pattern of the RS-precursor particulate of Example 4.

FIGS. 15a and b show SEM images of the RS-precursor particulate of Example 1 at different magnifications.

FIGS. 16a and b show SEM images of the RS-precursor particulate of Example 2 at different magnifications.

FIGS. 17a and b show SEM images of the RS-precursor particulate of Example 3 at different magnifications.

FIGS. 18a and b show SEM images of the RS-precursor particulate of Example 4 at different magnifications.

FIG. 19 shows XRD patterns of the SC-LiNMC particulate of Comparative Examples 4-6 and Examples 5 and 6.

FIG. 20 shows SEM images of the SC-LiNMC particulate of Comparative Examples 4-6 and Examples 5 and 6.

FIG. 21 shows first cycle voltage curves of the SC-LiNMC particulate of Comparative Examples 4-6 and Examples 5 and 6.

FIG. 22 shows plots of discharge capacity vs. cycle number of the SC-LiNMC particulate of Comparative Examples 4-6 and Examples 5 and 6.

FIG. 23 shows the XRD pattern of the SC-LiNMC particulate of Example 7.

FIGS. 24a and b show SEM images of the SC-LiNMC particulate of Example 7 at different magnifications.

FIG. 25 shows the first cycle voltage curve of the SC-LiNMC particulate of Example 7.

FIG. 26 shows the XRD pattern of the SC-LiNMC particulate of Example 8.

FIG. 27a and b show SEM images of the SC-LiNMC particulate of Example 8 at different magnifications.

FIG. 28 shows the first cycle voltage curve of the SC-LiNMC particulate of Example 8.

FIG. 29 shows the XRD pattern of the SC-LiNMC particulate of Example 9.

FIGS. 30a and b show SEM images of the SC-LiNMC particulate of Example 9 at different magnifications.

FIG. 31 shows the first cycle voltage curve of the SC-LiNMC particulate of Example 9.

FIG. 32 shows the XRD pattern of the SC-LiNMC particulate of Example 10.

FIG. 33 shows the SEM image of the SC-LiNMC particulate of Example 10.

FIG. 34 shows the first cycle voltage curve of the SC-LiNMC particulate of Example 10.

FIG. 35 shows the XRD pattern of the biphasic precursor particulates of Example 11.

FIGS. 36a and b show SEM images of the biphasic precursor particulates of Example 11.

FIG. 37 shows the XRD pattern of the SC-LiNMC particulate of Example 12.

FIG. 38 shows a SEM image of the SC-LiNMC particulate of Example 12.

FIG. 39 shows the first cycle voltage curve of the SC-LiNMC particulate of Example 12.

FIG. 40 shows the discharge capacity vs. cycle number of the SC-LiNMC particulate of Examples 10 and 12.

FIG. 41 shows the XRD pattern of the RS-precursor particulate of Example 13.

FIGS. 42a and 42b show SEM images of the RS-precursor particulate of Example 13 at different magnifications.

FIG. 43 shows the XRD pattern of the RS-precursor particulate of Comparative Example 7.

FIG. 44 shows the XRD pattern of the RS-precursor particulate of Example 14.

FIGS. 45a and 45b show SEM images of the RS-precursor particulate of Example 14 at different magnifications.

FIG. 46 shows the XRD pattern of the RS-precursor particulate of Example 15.

FIGS. 47a and 47b show SEM images of the RS-precursor particulate of Example 15 at different magnifications.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

The phrases “consisting essentially of” or “consists essentially of” are to be interpreted as limiting to the specified materials or steps involved (depending on context) but also to include—and not to exclude—any materials or steps that do not materially affect the basic and novel characteristics of the materials or steps involved. In particular, the expression “the feedstock triturating procedure produces a homogeneous feedstock particulate mixture consisting essentially of the nickel containing particulate phase, the manganese containing particulate phase, the cobalt containing particulate phase, and the optional dopant A containing particulate phase” is to be interpreted as potentially including amounts of other phases that are insignificant with regards to obtaining reasonable purities in the desired end products, whether such other phases are detectable by x-ray diffraction analysis or not.

In a related manner herein, the phrase “essentially the same” is to be interpreted as meaning “the same as” but also to include—and not to exclude—any items or steps that do not materially affect the basic characteristics of the items or steps involved.

In a related manner, the term “representative” may be used to refer to items or steps that provide essentially the same characteristics or results for all relevant practical and/or functional purposes associated with the items or steps that they are representative of. For instance, a specified heating procedure that produces a single-phase rock-salt precursor particulate in step c) from the homogeneous feedstock particulate mixture of step b) in the general method, is a “representative” heating procedure even though the set temperature and set time of the specified heating procedure differs from those of the heating procedure employed in step c).

The term “triturating” herein should be given its ordinary meaning as it would be understood by a person having ordinary skill in the art at the time of the invention but often refers to a process comprising both comminuting and blending.

The term “chemical reaction herein should be given its ordinary meaning as it would be understood by a person having ordinary skill in the art at the time of the invention but often refers the making or breaking of ionic or covalent bonds among elements in a molecule or ion or between molecules or ions.

The term “stoichiometric” herein should be given its ordinary meaning as it would be understood by a person having ordinary skill in the art at the time of the invention but often refers to the ratio of reactants in a chemical equation or formula. For example, H₂O refers to a ratio of two hydrogen atoms for every one oxygen atom in the water molecule and may be produced according to the stoichiometric equation 2H+O [symbol] H₂O. Stoichiometric values may be whole numbers or integers, or they may be fractions that could be multiplied by a number such that they are whole numbers or integers.

The term “molar ratio” herein should be given its ordinary meaning as it would be understood by a person having ordinary skill in the art at the time of the invention but often refers to the ratio between the amounts in moles of any two compounds. A mole of a substance is equivalent to 6.02214076×10²³ elementary entities (e.g., atoms, molecules, ions, electrons) of that substance.

In a quantitative context, the term “about” should be construed according to its ordinary meaning as it would be understood by a person having ordinary skill in the art at the time of the invention, but generally includes the range up to plus 1% and down to minus 1%.

The term “grain” should be given its ordinary meaning as it would be understood by a person having ordinary skill in the art at the time of the invention but often refers to a crystallite, the terms being used interchangeably herein.

“Particulate” should be given its ordinary meaning as it would be understood by a person having ordinary skill in the art at the time of the invention but often refers to a plurality of “particles” in which the “particles” are composed of one or more grains.

The term “average particle size” should be given its ordinary meaning as it would be understood by a person having ordinary skill in the art at the time of the invention but often refers to the average of the greatest dimension of at least 20 random particles as directly observed by SEM.

The term “average grain size” should be given its ordinary meaning as it would be understood by a person having ordinary skill in the art at the time of the invention but often refers to the grain size as determined by applying the Scherrer equation to the largest x-ray diffraction peak of the particulate for grain sizes less than 100 nm. For grain sizes of 100 nm or more, the average grain size refers to the average length of the greatest dimension of at least 20 random particles as directly observed by SEM.

The term “single crystal lithium nickel manganese cobalt oxide particulate” or SC-LiNMC should be given its ordinary meaning as it would be understood by a person having ordinary skill in the art at the time of the invention but often refers to a lithium nickel manganese cobalt oxide particulate in which its constituent particles are comprised of one or more grains, the average grain size being at least 1 μin size.

The term “phase” should be given its ordinary meaning as it would be understood by a person having ordinary skill in the art at the time of the invention but often refers to a distinct and homogeneous form of matter separated at its surface from other forms of matter.

The term “rock-salt phase” should be given its ordinary meaning as it would be understood by a person having ordinary skill in the art at the time of the invention but often refers to an oxide phase having a cubic rock-salt crystal structure that is absent of cation layering order. Such rock-salt phases are also known as “disordered rock-salts”.

The term “single-phase rock-salt” or “single rock-salt phase” should be given its ordinary meaning as it would be understood by a person having ordinary skill in the art at the time of the invention but often refers to a material in which its XRD pattern corresponds to that of a single rock-salt phase. However, some compositional variation may occur in the single-phase rock-salt material either within a single particle or between different particles, which can manifest itself in peak broadening.

“Metal dopant” should be given its ordinary meaning as it would be understood by a person having ordinary skill in the art at the time of the invention but often refers to the group of metals capable of serving as a dopant in a lithium transition metal oxide and includes the metals Mg, Al, Ti, Zr, W, Zn, Mo, K, Na, Si, Ta, and mixtures thereof but excludes the metals Ni, Mn, and Co.

The term “metal-ion cell” or “metal-ion battery” should be given its ordinary meaning as it would be understood by a person having ordinary skill in the art at the time of the invention but often refers to alkali metal ion cells, including for instance lithium ion cells.

The term “cathode” should be given its ordinary meaning as it would be understood by a person having ordinary skill in the art at the time of the invention but often refers to the electrode at which reduction occurs when a metal-ion is discharged. In a lithium ion cell, the cathode is the electrode that is lithiated during discharge and delithiated during charge.

The term “anode” should be given its ordinary meaning as it would be understood by a person having ordinary skill in the art at the time of the invention but often refers to the electrode at which oxidation occurs when a metal-ion cell is discharged. In a lithium ion cell, the anode is the electrode that is delithiated during discharge and lithiated during charge.

The term “half-cell” should be given its ordinary meaning as it would be understood by a person having ordinary skill in the art at the time of the invention but often refers to a cell that has a working electrode and a metal counter/reference electrode. A lithium half-cell has a working electrode and a lithium metal counter/reference electrode.

The term “primary particle” should be given its ordinary meaning as it would be understood by a person having ordinary skill in the art at the time of the invention but often refers to a particle composed of a single grain.

The term “secondary particle” should be given its ordinary meaning as it would be understood by a person having ordinary skill in the art at the time of the invention but often refers to an agglomerate of two or more primary particles.

The term “apparent lattice strain” should be given its ordinary meaning as it would be understood by a person having ordinary skill in the art at the time of the invention but often refers to the result of a Williamson-Hall lattice strain analysis of an XRD pattern of a material. The result of the lattice strain determined by this method being due to actual strain in the lattice (normal lattice strain) or peak broadening caused by compositional variation in the sample or a combination of both.

The term “flux” should be given its ordinary meaning as it would be understood by a person having ordinary skill in the art at the time of the invention but often refers to a substance or a mixture of substances that is added to during a heating step to aid in a solid-state reaction or to aid in the crystallization of the material or reactants being heated by being molten during the heating step and partially solubilizing the material or reactants or partially solubilizing a component of the material or reactant, while not incorporating impurities into the crystal structure of the final products. In other words, the flux remains as a separate phase or phases from the material or reactants being heated and from the final products before, during, and after the heating step.

For purposes of preparing lithium nickel manganese cobalt oxide particulate, it has been discovered that desirable, phase pure, crystalline precursor particulate having the rock-salt phase and having the formula (NiₙMnₘCo_{c})₁₋ₐAₐO can be made primarily by mechanical and thermal processing methods. Here, A is an optional metal dopant; and n, m, c and a are positive numbers wherein n+m+c=1; n≥0.05; m≥0.05; c≥0.05; and 0≤a≤0.05. The metal dopant, A can be Mg, Al, Ti, Zr, W, Zn, Mo, Si or Ta or combinations thereof. The precursor particulates furthermore have grain sizes that are greater than 20 nm. Such crystalline rock-salt phases in this composition range are not known to have been previously isolated in their pure form.

The synthesis of the precursor particulate includes a step of triturating suitable feedstock component particulates (at least a nickel containing particulate, a manganese containing particulate, and a cobalt containing particulate) together to form a homogeneous feedstock particulate mixture. Suitable trituration methods include dry and wet trituration methods (e.g. jet milling, ball milling, bead milling, small media milling, agitator ball milling, planetary milling, horizontal ball milling, pebble milling, rod milling, attritor milling, pulverizing, hammer milling, mortar grinding). However, dry trituration methods may be preferred as they do not require a subsequent step to separate the feedstock particulate mixture from water and they do not produce wastewater. Trituration methods that do not require media are also desirable, such as jet milling and mortar grinding, since such methods result in less feedstock contamination during trituration processing.

The feedstock component particulates can include powdered oxides or hydroxides of nickel, manganese, cobalt and, optionally, metal dopant A, such as CoO, Co₃O₄, Co(OH)₂, Co(OH)₃, NiO, Ni(OH)₂, MnO, Mn₃O₄, MnO₂, Mn(OH)₂, MgO, TiO, TiO₂, In exemplary embodiments, the feedstock component particulates are metal (II) oxides, including MnO, CoO, NiO (all having rock-salt structure), and optionally MgO and TiO. In other embodiments, the feedstock component particulates can include metal (III) oxides ore metal (IV) oxides, such as Mn₃O₄, MnO₂, and Co₃O₄. In some embodiments, the feedstock component particulates are metal (II) hydroxides, including Ni(OH)₂, Mn(OH)₂, and Co(OH)₂ or metal carbonates, such as NiCO₃, MnCO₃ or CoCO₃. In some embodiments, the feedstock component particulates may be mixtures of one or more metal oxide and one or more metal hydroxide. In some embodiments, the feedstock component particulates may be mixtures of one or more metal (II) oxide and one or more metal (II) hydroxide.

In some embodiments, the feedstock component particulates may also comprise a flux. Suitable fluxes are those that are molten when the feedstock component mixture is heated to form a rock-salt precursor particulate during a rock-salt forming heating procedure. However, such fluxes should not result in the formation of impurities in the rock-salt precursor particulate crystal structure, but should rather co-exist as a separate phase with the feedstock component mixture or rock-salt precursor particulate prior to, during, and after the rock-salt forming heating procedure. Such fluxes may enhance the diffusion of transition metals during the rock-salt forming heating procedure, resulting in greater compositional homogeneity in the as formed rock-salt precursor particulate. Examples of suitable fluxes include alkali metal sulfate salts, such as Li₂SO₄, Na₂SO₄, K₂SO₄ and combinations thereof; B₂O₃, WO₃, BiO₂, and MoO₃. In some embodiments, salts which additionally are soluble in water can be particularly useful, since such fluxes may be removed by washing with water after the rock-salt forming heating procedure.

Exemplary homogeneous feedstock particulate mixtures include those in which all the feedstock component particulates are composed of separated or loosely aggregated primary particles having an average size that is less than 10 μm, less than 1 μm, less than 0.5 μm or less than 0.2 μm. Generally, a homogeneous feedstock particulate mixture may be obtained from triturating a mixture of feedstock component particulates that contains secondary particles that have an average size that is larger than 20 μm, which consist of densely packed or fused together primary particles, sufficiently to obtain feedstock component particulates that are composed of separated or loosely aggregated primary particles having an average size that is less than about 10 μm, less than about 1 μm or even more preferred, less than about 0.5 μm or even smaller by triturating a mixture of feedstock component particulates results in a feedstock particulate mixture that is suitably homogeneous. The feedstock particulate mixture may be considered homogeneous on a macro scale, substantially homogeneous on an atomic scale, or sufficiently homogeneous for atomic-level diffusion to produce a lattice strain less than about 0.3%.

The triturating procedure used to prepare the homogeneous feedstock particulate mixture may involve selecting a suitable triturating apparatus and process to use with that triturating apparatus (e.g. selecting a certain milling apparatus and certain operating speed to use with that milling apparatus) and then triturating the mixture using that apparatus and process for a certain triturating time. Whatever the triturating apparatus and process is selected, the triturating step should be performed sufficiently to produce a feedstock particulate mixture which is homogeneous and in which the feedstock component particulates have a reduced particle size and in which any secondary particles comprised of densely packed or fused together primary particles have been broken down into dispersed or loosely aggregated primary particles. However, the step of triturating feedstock component particulates should not be performed to an extent where a chemical reaction occurs between the feedstock component particulates (e.g. where two feedstock component particulates of different chemical compositions combine to produce a third chemical composition) as determined by x-ray diffraction analysis. The occurrence of a chemical reaction between the feedstock component particulates during the step of triturating feedstock component particulates is indicative that the step of triturating feedstock component particulates is too aggressive. Under such aggressive conditions excess wear of the trituration apparatus and media typically results in excessive contamination of the feedstock particulate mixture. The desired outcomes can be obtained by using a triturating time that is both long enough to achieve the desired homogeneity and comminution, yet not too long so as to result in significant chemical reaction.

The determination of an appropriate triturating time for preparing the homogeneous feedstock particulate mixture is thus particularly important and varies according to what feedstock particulates are used, along with what triturating apparatus and associated process are used. Fortunately, appropriate triturating times can be determined using either a direct method or an indirect method. In either case, the test for determining that the desired homogeneity and comminution has been achieved involves heating the homogeneous feedstock particulate mixture or a representative feedstock particulate mixture using a representative heating procedure to verify that the desired single-phase rock-salt precursor particulate with the desired apparent lattice strain is indeed obtained after the heating. An example of a suitable representative heating procedure is to heat the homogeneous feedstock particulate mixture for about 12 hours at about 1000° C. under an argon flow. As mentioned above in either case, x-ray diffraction analysis may be used as a test for determining that a triturating time was not excessive and that no significant chemical reaction has occurred. As illustrated in the following Examples, an advantage of the disclosed methods is that exemplary triturating times can range from as little as 10 minutes to 6 days.

A direct procedure for determining a suitable triturating time simply involves obtaining one or more samples from time to time from the mixture as it is undergoing triturating. Such samples are then heated according to a representative heating procedure and the structure and apparent lattice strain of the heated samples determined via x-ray diffraction analysis. Triturating continues until a heated sample is determined to have the desired single-phase rock-salt structure and apparent lattice strain, at which point the triturating is sufficient and the time spent triturating thus represents a suitable triturating time. The direct procedure can additionally comprise determining the structure of the obtained samples via x-ray diffraction analysis before heating the obtained samples to ensure the obtained samples consist essentially of the nickel containing particulate phase, the manganese containing particulate phase, the cobalt containing particulate phase, and the optional dopant A containing particulate phase.

An indirect procedure for determining a suitable triturating time involves predetermining the triturating time. Here, one or more representative sample mixtures of the nickel containing particulate, the manganese containing particulate, and the cobalt containing particulate may be prepared in advance and then triturated for different periods of time. In a like manner to the direct procedure, the representative sample mixtures can then be heated according to a representative heating procedure, the structure and apparent lattice strain of the heated representative sample mixtures determined via x-ray diffraction analysis, and a suitable triturating time determined based on which triturating time periods result in heated representative sample mixtures having a desired single-phase rock-salt structure and apparent lattice strain. Alternatively, as those of ordinary skill will readily appreciate, once the suitable triturating time for the feedstock component particulates and the triturating method is determined, the suitable triturating time may be used in future for the same combination of the feedstock component particulates and the method.

In the preceding, the representative sample mixtures, representative triturating apparatus and associated processes, and representative heating procedures used may of course be the same as those used in the ultimate actual preparation of desired LiNMC particulate. However, those of ordinary skill in the art realize that being “representative” does not require being the same. Significant variations in material types, apparatus choices, milling speeds (where appropriate), heating temperatures and so forth may still be expected to be representative enough for determining satisfactory triturating times.

To complete synthesis of the desired precursor particulate, the homogeneous feedstock particulate mixture is heated according to a heating procedure which involves heating to a set temperature for a set time under a suitable heating atmosphere. Exemplary suitable heating atmospheres include inert gases, such as N₂, Ar, and He. In some embodiments, a reduced oxygen partial pressure gas may be used, such as CO₂. In some embodiments, a vacuum may be used as a suitable heating atmosphere. In some embodiments, the heating atmosphere is an inert gas that is flowed over the sample. In some embodiments a “getter” may be placed upstream of the homogeneous feedstock particulate mixture in a heating atmosphere inert gas flow. Suitable getters include elements and compounds that reduce the oxygen partial pressure in the heating atmosphere and include metal particulate, metal sponges, and metal oxide particulate. Exemplary getters include titanium particulate, titanium sponge and MnO particulate.

Exemplary set temperatures are greater than about 500° C. greater than about 700° C. greater than about 800° C. or greater than about 900° C. In some embodiments, the set temperature for the heating step may be between about 500° C. and about 1600° C. between about 500° C. and about 1200° C. between about 500° C. and about 1100° C. between about 500° C. and about 900° C. Exemplary set times are greater than about 1 h, greater than about 2 h, greater than about 5 h, or greater than about 10 h. In some embodiments, the set time for the heating step is between about 1 h and about 20 hrs, between about 1 h and about 15 hrs, or between about 1 h and about 12 hrs. Using such heating procedures, the homogeneous feedstock particulate mixtures prepared according to the above react to form a crystalline precursor particulate having an XRD pattern characteristic of a single rock-salt (RS) phase and having the formula (NiₙMnₘCo_{c})₁₋ₐAₐO (RS-precursor particulate) with a grain size greater than 20 nm. The RS-precursor particulate can be further characterized by having no other metal oxide phases present, as detected by x-ray diffraction analysis (XRD). In some embodiments, the RS-precursor particulate may contain small amounts of a metallic phase, such as Ni, due to the reduction of Ni²⁺ during heating in an inert or reducing atmosphere. In some embodiments, the RS-precursor particulate may also contain a phase or phases due to the presence of a flux. When the step of triturating is not sufficient to achieve homogeneity in the feedstock particulate mixture, the mixture is unable to form rock-salt precursor particulate by heating in an inert atmosphere. In such a situation, an XRD pattern characteristic of a multiphase mixture of metal oxides may be obtained. Such XRD patterns comprise discernable peaks from phases not having the rock-salt structure. Therefore, the presence of a multiphase mixture of metal oxides after heating the feedstock particulate mixture in an inert atmosphere is indicative of reduced homogeneity in the RS-precursor particulate, which is believed to result in reduced homogeneity in a final LiNMC product particle and poorer electrochemical performance.

In another aspect, the method can additionally comprise: before a rock-salt forming heating procedure, forming the homogeneous feedstock particulate mixture into a pellet. This may be accomplished with a pellet die and a press or a pelletizing machine. Forming the homogeneous feedstock particulate mixture can enhance solid state diffusion during a rock-salt forming heating procedure, resulting in improved compositional homogeneity in the as formed precursor particulate.

It has been found that exemplary RS-precursor particulates can have low apparent lattice strain, as determined by analysis of their XRD pattern by the Williamson-Hall method. Without being bound by theory, in some embodiments the apparent lattice strain may be due to strain in the lattice (normal lattice strain). It is believed that a low normal lattice strain is indicative of a homogenous distribution of metals in the rock-salt precursor particulate crystal structure. In other embodiments the apparent lattice strain may be due to the presence of rock-salt phases having a distribution of compositions. This distribution can result in an XRD pattern corresponding to a single-phase RS-precursor particulate with peak broadening due to a distribution of lattice constants from a distribution of RS-precursor particulate phase compositions in the sample. The XRD peak broadening in this case may also be quantified as apparent lattice strain using the Williamson-Hall method. Thus, RS-precursor particulate having a low apparent lattice strain corresponds to a homogeneous distribution of metals in the RS-precursor particulate. In some embodiments, exemplary RS-precursor particulate have apparent lattice strains lower than about 0.3%, lower than about 0.2% or even lower. In some embodiments, it has been found that RS-precursor particulate having an apparent lattice strain of about 0.2% or less, and especially about 0.1% or less are particularly useful. Such RS-precursor particulate have an exceptionally high degree of homogeneity. LiNMC made from such RS-precursor particulate can have desirable characteristics, such as high initial coulombic efficiency, low capacity fade and low voltage polarization.

It has also been found that heating certain RS-precursor particulate in air can produce a useful novel biphasic precursor particulate consisting essentially of two oxide phases; one having a rock-salt structure and the other having a cubic spinel structure. The biphasic precursor particulate has the composition (NiₙMnₘCo_{c})₁₋ₐAₐO_{b} where n, m, c, a are positive numbers, A is a metal dopant, and n+m+c=1; n≥0.05; m≥0.05; c≥0.05; 0≤a≤0.05; and 1<b<1.33. In some embodiments b is about n+4(m+c)/3. The oxide phase having a rock-salt structure can be NiO, while the oxide phase having the cubic spinel structure can be a cobalt manganese oxide spinel with the chemical formula M₃O₄ in which M is a mixture of Mn and Co. In some embodiments, M may additionally comprise Ni. In some embodiments, M may additionally comprise dopant elements. In some embodiments, M may additionally comprise Li. Further, the cubic spinel phase can have a lattice constant in the range of 8.1 Å to 8.4 Å. Exemplary biphasic precursor particulate are formed from RS-precursor particulate with a high degree of homogeneity, that is RS-precursor particulate with lattice strains less than about 0.3%, less than about 0.2%, less than about 0.1% or even smaller. In some embodiments, the biphasic precursor particulate may also contain a phase or phases due to the presence of a flux.

It has been found that exemplary biphasic precursor particulate has narrow XRD peaks corresponding to grain sizes greater than about 100 Å or even greater than about 200 Å, as determined by applying the Scherrer equation to the largest diffraction peak of each oxide phase. In some instances, the grain sizes may exceed a size that is measurable by common laboratory x-ray diffractometers. In that case the grain size may also be determined by observations of the average crystallite size using SEM. Grain sizes larger than about 500 Å, about 100 nm, about 500 nm or even larger than about 1000 nm are desirable. However, grain sizes that are too large (e.g., greater than 5000 nm) are not desirable, since their lithiation during the LiNMC forming heating procedure can be too slow, resulting in poor LiNMC formation. Without being bound by theory, broader XRD peaks may indicate that a mixture of different metal oxide phases having the cubic spinel and rock-salt structure are formed, each having a different metal composition and a different lattice constant. When the XRD pattern of such a multiphase mixture is measured, the individual peaks from each phase associated with a particular Miller index can combine to give the appearance of a single broad XRD peak, resulting in an apparent small grain size, as determined by the Scherrer equation. Such a multiphase mixture of rock-salt oxide and cubic spinel oxide phases has low homogeneity in its distribution of transition metals compared with a biphasic precursor particulate of the same overall composition. Therefore, such precursor particulates with small grain sizes as determined by the Scherrer equation are less desirable.

To prepare the final lithium nickel manganese cobalt oxide particulate, precursor particulate (RS-precursor particulate or biphasic precursor particulate) is combined with a lithium source obtained in the form of a lithium containing particulate by blending or triturating. Suitable lithium containing particulates include Li₂CO₃, Li₂O, and LiOH·H₂O. The step of combining an amount of this lithium containing particulate may be accomplished by commonly used blending or trituration processes, such as v-blending, tumbling, mixing, jet milling, ball milling, bead milling, small media milling, agitator ball milling, planetary milling, horizontal ball milling, pebble milling, rod milling, attritor milling, pulverizing, hammer milling, and mortar grinding. Again, most preferred are those dry blending and trituration methods that do not require media, such as jet milling and mortar grinding, since such methods result in less contamination during processing. As before, this combining step is preferably not performed to an extent where a chemical reaction occurs between the precursor and the lithium particulates. This may be indicative that this combining step is too aggressive. Under aggressive conditions, excess wear of the mixing apparatus and media typically result in excessive contamination of the mixture. In order to ensure thorough lithiating, the amount of the lithium containing particulate used is typically greater than or equal to the stoichiometric amount required to make the lithium nickel manganese cobalt oxide particulate (e.g. about 5% to about 20% greater).

In addition to combining the precursor particulate (RS-precursor particulate or biphasic precursor particulate) with a lithium source, a flux may also be added. Suitable fluxes are those that are molten when the precursor particulate lithium source mixture is heated to form LiNMC during a NMC forming heating procedure. However, such fluxes should not result in the formation of impurities in the LiNMC crystal structure, but should rather co-exist as a separate phase with the LiNMC after the NMC forming heating procedure. In some instances, the flux may combine with the lithium source to form a lithium containing flux during the NMC forming heating procedure. For instance, BiO₂ may be used as a flux that combines with the lithium source to form a Li₇BiO₆ flux during the NMC forming heating procedure. In such instances, an additional amount of lithium source may be required to account for the lithium that forms a lithium containing flux. Such fluxes may enhance the diffusion of transition metals during the rock-salt forming heating procedure, resulting in greater compositional homogeneity in the as formed rock-salt precursor particulate. Examples of suitable fluxes include alkali metal sulfate salts, such as Li₂SO₄, Na₂SO₄, K₂SO₄ and combinations thereof; B₂O₃, WO₃, BiO₂, and MoO₃. In some embodiments, salts which additionally are soluble in water can be particularly useful, since such fluxes may be removed by washing with water after the NMC forming heating procedure.

After combining the precursor particulate with an amount of the lithium containing particulate, the precursor particulate lithium source mixture is heated in an oxygen containing gas (the NMC forming heating procedure) in a conventional manner well known to those in the art in order to form LiNMC, including SC-LiNMC. This heating procedure may be accomplished in a box, tube or other suitable furnace with flowing oxygen containing gas. Typical oxygen containing gases include oxygen, air, dry air or mixtures of oxygen and inert gases. Further, the NMC forming heating procedure may be performed in a single heating step or in multiple heating steps with multiple gases and multiple temperatures. Between heating steps, samples may be collected and ground and a further source of lithium may be added. The lithiating temperatures used in this heating procedure may be greater than 700° C. and even greater than 1000° C. An exemplary range however is from about 800 to 900° C. Further, the heating may be performed for times greater than 1 hour or even greater than 10 hours. An exemplary time however is about 9 hours. Heating times greater than 20 hours or temperatures greater than 1200° C. are generally avoided though, since they can result in excessive lithium loss.

In another aspect, the method can additionally comprise: before a lithium nickel manganese cobalt oxide forming heating procedure, forming the precursor particulate lithium source mixture into a pellet. This may be accomplished with a pellet die and a press or a pelletizing machine. Forming the precursor particulate lithium source mixture into a pellet can reduce lithium loss during lithium nickel manganese cobalt oxide forming heating procedure as opposed to heating the precursor particulate lithium source mixture as a loose powder. Forming the precursor particulate lithium source mixture into a pellet can also enhance solid state diffusion, resulting in improved compositional homogeneity in the LiNMC product.

For present purposes, SC-LiNMC is defined as a LiNMC particulate in which its constituent particles are comprised of one or more grains, the average grain size being at least 1 μm in size. In some embodiments the SC-LiNMC average grain size may be 2 μm, 5 μm, 10 μm or even greater. However, SC-NMC average grain sizes that are too large may result in poor lithium diffusion. Therefore SC-LiNMC grain sizes that are less than 20 μm are preferred.

In some embodiments, the SC-LiNMC particulate may be in the form of particles comprising on average only a single grain. In other embodiments, the SC-LiNMC particulate may comprise secondary particles that are made up of a plurality of grains. In the latter instance, further processing steps may be used to break up the secondary particles into smaller secondary particles or even individual grains. Suitable processing steps for this purpose include jet milling, and dry or wet grinding or milling methods, such as bead milling.

In certain instances, it was found that it is more difficult to form LiNMC with desirable electrochemical properties by heating a precursor particulate lithium source mixture than if a mixture of a lithium source with a conventional NMC hydroxide precursor was used. In such embodiments, heating a precursor particulate lithium source mixture can result in excessive lithium evaporation, low lithiation levels in the final LiNMC, and multiphase formation. Without being bound to theory, it is believed that during a LiNMC forming heating procedure, lithium diffusion is much slower in the precursor particulate than in the typically used NMC hydroxide precursors. As a result, traditionally used lithium sources, such as Li₂CO₃ and LiOH·H₂O may tend to melt and segregate from the rock-salt precursor particulate before complete lithiation can take place in a LiNMC forming heating procedure. In order to achieve fully lithiated and single-phase LiNMC, it has been found that lithium sources that do not melt at the lithiating temperatures used in embodiments disclosed herein are especially useful. An example of such an exemplary lithium source is Li₂O.

In some embodiments, during the LiNMC forming heating procedure an additional lithium source may be introduced in the gas flow in the heated zone of the furnace upstream of the triturated precursor/lithium particulate mixture. This additional lithium source can be in the form of Li₂O, Li₂CO₃ or LiOH·H₂O powders. Without being bound by theory, it is believed that the use of an additional lithium source during the LiNMC forming heating procedure can increase the partial pressure of lithium containing species in the furnace, resulting in reduced lithium evaporation from the triturated precursor/lithium particulate mixture during heating and also an increased level of lithiation in the final LiNMC product.

It has also been found that the aforementioned biphasic precursor particulate can be lithiated much more efficiently than the rock-salt precursor particulate, thus avoiding issues with lithium loss during the LiNMC forming heating procedure. Without being bound to theory, it is envisioned that transformation of the single-phase rock-salt precursor to the biphasic precursor particulate results in the formation of grain boundaries, through which lithium may diffuse more efficiently, resulting in more facile lithiation of the latter. In addition, it is thought that the lithium may diffuse more efficiently through the spinel oxide phase compared to the rock-salt oxide phase, also resulting in more facile lithiation of the biphasic precursor particulate.

Once prepared as in the preceding manner, the LiNMC particulate is generally ready for conventional use in its intended application. In battery applications, electrodes and electrochemical devices employing LiNMC particulate may be prepared in numerous manners known to those in the art. For instance, there are numerous optional designs and methods for making cathode electrodes for rechargeable lithium ion batteries as well as for making the batteries themselves and these have been documented extensively in the art.

The disclosed methods advantageously involve dry, lower energy triturating apparatus and processes that take less time to prepare precursor particulate than prior art methods. The present methods therefore are simple, fast, and result in reduced contamination in the product particulate. For instance, notwithstanding the results of the methods disclosed in the aforementioned published PCT application WO2021/041296, the present methods can achieve desirable results faster, using lower energy triturating, and hence with reduced chance of impurities present. The present methods distinguish over those in WO2021/041296 in that the latter result in chemical reaction between the particulates in the feedstock whereas the former do not and instead a multiple phase triturated mixture of the original feedstock particles is retained. Further, the former involves a heating step in inert gas after the triturating step.

While embodiments herein have been described, it should be appreciated by a person having ordinary skill in the art that the embodiments may be combined in various way to produce a process that is advantageous over the prior art. A person having ordinary skill in the art would also appreciate the disclosure as a whole. Although various benefits and advantages have been described with regard to individual sub-processes, the processes disclosed herein may provide a synergistic effect over the prior art. For example, while not wanting to be bound by any embodiment or combination of embodiments, triturating in tandem with pelletizing and adding a flux can provide a synergistic effect that is not appreciated by the disclosures of the prior art.

The following examples are illustrative of certain aspects of embodiments disclosed herein but should not be construed as limiting the embodiments in any way. Those skilled in the art will readily appreciate that other variants are possible for the methods used and materials produced herein.

### EXAMPLES

Exemplary lithium nickel manganese cobalt oxide particulates and precursor particulates with rock-salt structure were prepared using dry processing methods in accordance with embodiments herein. Other precursor particulate was also prepared for comparison purposes. Various characteristics of these particulates were determined and presented below. In addition, electrodes and electrochemical cells were prepared using some of these lithium nickel manganese cobalt oxide particulates. The cell performance results obtained from the electrochemical cells are also presented below.

### Material Characterization

X-ray diffraction (XRD) patterns were collected using a Rigaku Ultima IV diffractometer equipped with a Cu Ka X-ray source, a diffracted beam graphite monochromator and a scintillation detector.

Scanning electron microscope (SEM) images were obtained using a JEOL 840-SEM or a TESCAN MIRA 3 LMU Variable Pressure Schottky Field Emission Scanning Electron Microscope (SEM).

Average particle sizes were determined from SEM images. Average grain sizes were determined from SEM images or by application of the Scherrer equation to XRD peak full widths at half maximum. In the case of average particle or grain sizes determined from SEM images, these averages were based on the greatest dimension of at least 20 random particles or grains respectively as directly observed by SEM.

### Electrode Preparation

Sample electrodes for laboratory testing were prepared from slurries prepared by mixing 0.920 g of the prepared LiNMC particulate, 0.040 g carbon black (Super C65, Imerys Graphite and Carbon), and 0.040 g polyvinylidene fluoride binder (PVDF, Kynar HSV 900) in an LiNMC particulate/carbon black/PVDF mass ratio of 92/4/4 with 1.4 g of N-methyl-2-pyrrolidone (NMP, Sigma Aldrich, anhydrous 99.5%). Slurries were mixed for 15 minutes using a high-shear mixer equipped with a Cowles-type blade impeller rotating at 2000 rpm. The resulting slurries were then spread onto aluminum foil (Furukawa Electric, Japan) with a 0.006 inch gap coating bar. The coatings were then dried in air for 1.5 h at 120° C. cut into 1.3 cm disks and then heated under vacuum overnight at 120° C.

### Electrochemical Test Cell Preparation

To evaluate the various materials as electrode materials in Li-ion cells, laboratory test lithium half-cells (also referred to here as electrochemical test cells) were constructed and tested. Cathode electrodes utilizing prepared LiNMC particulate as their active material were assembled in 2325-type coin lithium half-cells with a lithium foil (99.9%, Sigma Aldrich) counter/reference electrode. (Note: as is well known to those skilled in the art, results from these test lithium half-cells allow for reliable prediction of electrode materials performance in lithium ion batteries.) Two layers of Celgard 2300separator and one layer of blown microfiber (3M company) were used in each coin lithium half-cell. 1M LiPF₆ (BASF) in a solution of ethylene carbonate, diethyl carbonate and monofluoroethylene carbonate (volume ratio 3:6:1, all from BASF) was used as electrolyte. Cell assembly was carried out in an Ar-filled glove box. Cells were cycled galvanostatically at 30.0±0.1° C. between 2.5 V and 4.3 V and at C/20 (initial cycle) and C/5 (subsequent cycles) rates using a Maccor Series 4000 Automated Test System.

### Feedstock Particulates

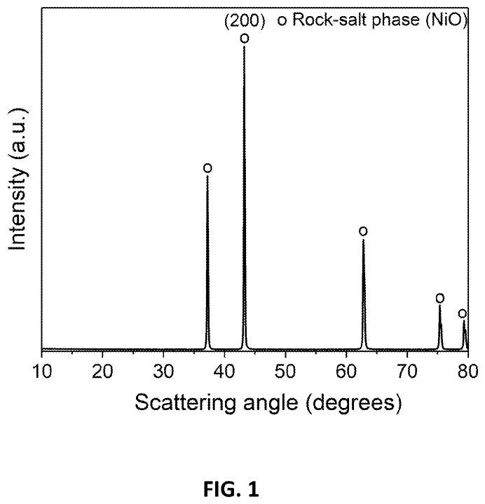

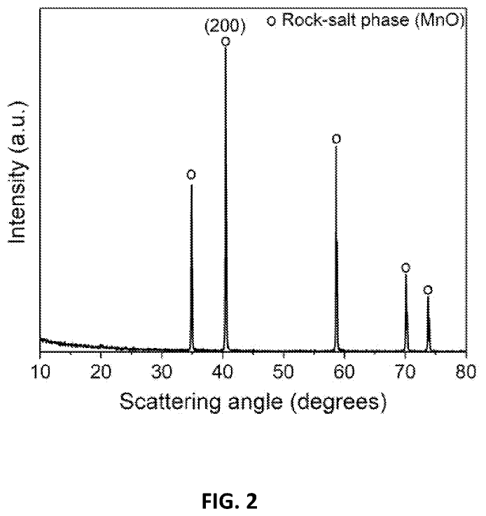

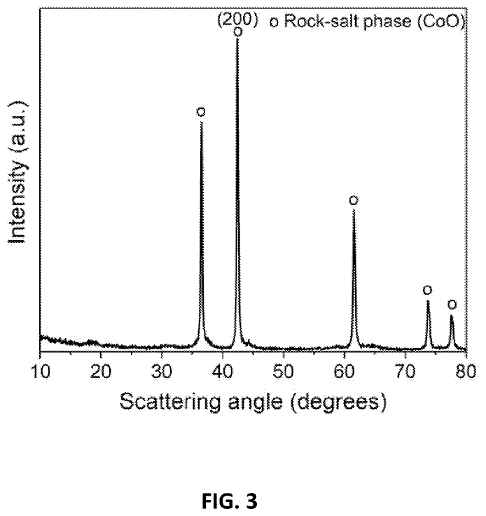

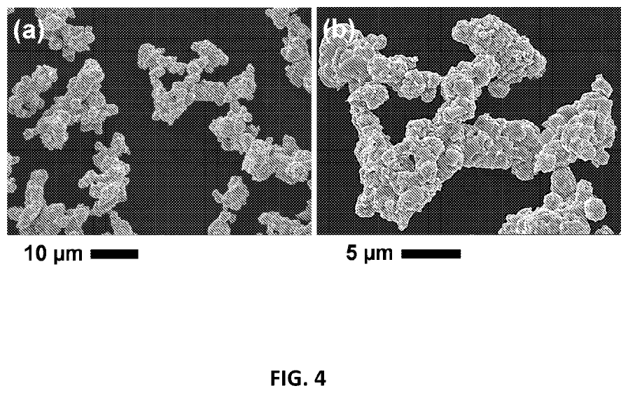

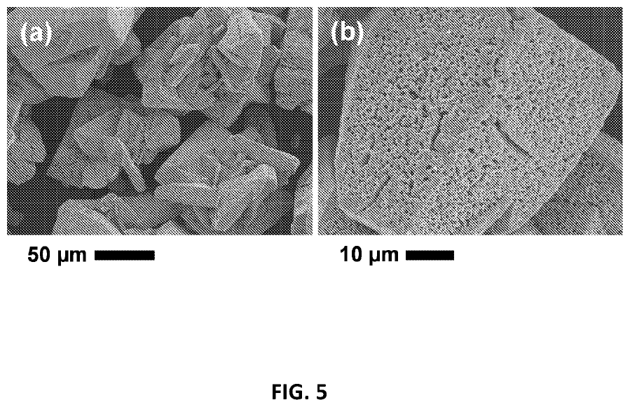

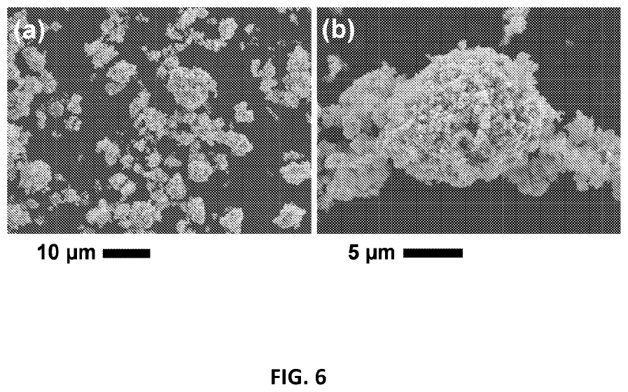

The feedstock particulates used to prepare precursor particulate in these examples included NiO (Sigma-Aldrich, −325 mesh, 99%), MnO (Aldrich, −60 mesh, 99%), 4.05 g CoO (Alfa Aesar, 99.7%). FIGS. 1-3 show the XRD patterns of the NiO, MnO, and CoO feedstock particulate respectively. All are phase pure and characteristic of having a rock-salt structure. FIGS. 4-6 show SEM images of the NiO, MnO, and CoO feedstock particulates respectively. NiO feedstock particulate consists of ˜0.5 μm grains that are fused together into particles that are 5-50 μm in size. MnO feedstock particulate consists of ˜5 μm grains that are fused together into particles that are 100-500 μm in size. CoO feedstock particulate consists of ˜0.5 μm grains that are aggregated together into particles that are 5-50 μm in size.

### Comparative Example 1

### RS-Precursor Particulate Made by Hand Grinding Feedstock Component Particulates

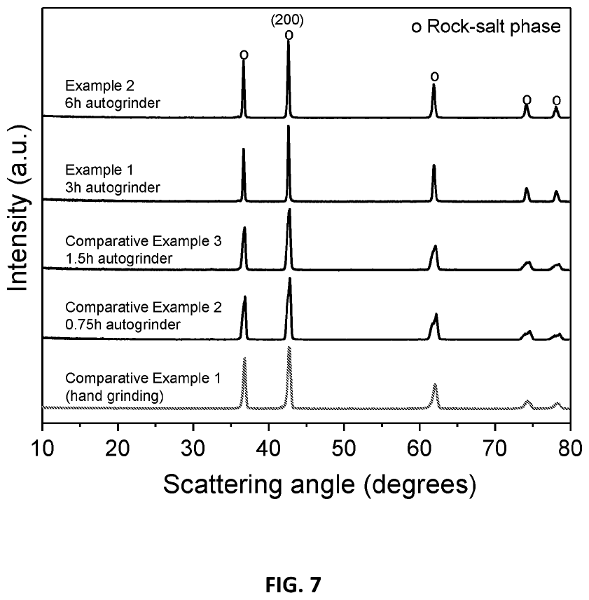

RS-precursor particulate Comparative Example 1 having the chemical formula Ni_{0.6}Mn_{0.2}Co_{0.2}O was prepared by triturating 12.11 g NiO (Sigma-Aldrich, −325 mesh, 99%), 3.84 g MnO (Aldrich, −60 mesh, 99%), and 4.05 g CoO (Alfa Aesar, 99.7%) feedstock particulates by hand grinding in a mortar and pestle. The resulting mixture was placed in an alumina crucible and heated in a tube furnace for 12 hours at 1000° C. under an argon flow. An alumina crucible filled with MnO powder was placed upstream in the furnace tube as an oxygen getter. The resulting RS-precursor particulate was ground in a mortar and pestle and passed through a 53 μm sieve. FIG. 7 shows the XRD pattern of the resulting RS-precursor particulate, which is characteristic of a phase pure rock-salt structure with a lattice constant of 4.234 Å. The apparent lattice strain was determined by the Williamson-Hall method to be 0.413%, which exceeds an apparent lattice strain value of 0.3%, indicating poor compositional homogeneity in this sample. The grinding and heating conditions of this sample, its lattice constant and apparent lattice strain value are listed in Table 1.

### Comparative Examples 2 and 3

### RS-Precursor Particulate Made by Autogrinding Feedstock Component Particulates for Insufficient Time

RS-precursor particulate Comparative Examples 2 and 3 having the chemical formula Ni_{0.6}Mn_{0.2}Co_{0.2}O were prepared in the same manner as Comparative Example 1, excepting that an autogrinder (Pulverisette 2 Mortar Grinder, Fritsch GmbH) was used as the trituration method to prepare a feedstock particulate mixture. Furthermore, the trituration time for Comparative Examples 2 and 3 were 0.75 h and 1.5 h, respectively.

FIG. 7 shows the XRD patterns of the resulting RS-precursor particulates, which are characteristic of a phase pure rock-salt structure with lattice constants of 4.237 Å for Comparative Example 2 and 4.239 Å for Comparative Example 3. The apparent lattice strain was determined by the Williamson-Hall method to be 0.572% for Comparative Example 2 and 0.472% for Comparative Example 3, both of which exceed an apparent lattice strain value of 0.3%, indicating poor compositional homogeneity in these samples. The grinding and heating conditions of these samples, their lattice constants, and their apparent lattice strain values are listed in Table 1.

### Examples 1-4

### RS-Precursor Particulates Made by Autogrinding Feedstock Component Particulates

RS-precursor particulate Examples 1-4 having the chemical formula Ni_{0.6}Mn_{0.2}Co_{0.2}O were prepared in the same manner as Comparative Example 2, excepting different trituration times by autogrinding were used and, in some cases, different heating temperatures were used. The grinding and heating conditions of these samples, their lattice constants, and their apparent lattice strain values are listed in Table 1.

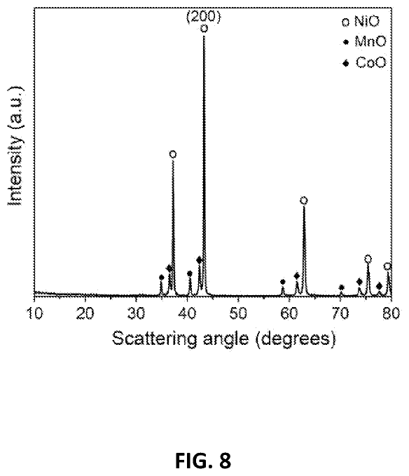

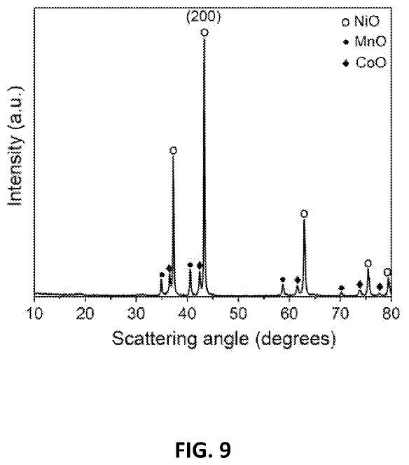

FIGS. 8 and 9 show XRD patterns of the feedstock particulate mixtures prepared after triturating the feedstock component particulate of Examples 1 and 2 respectively. These XRD patterns are characteristic of a mixture of NiO, MnO, and CoO phases, all having the rock-salt structure with no other phases present. That is, no chemical reaction was detected between the three feedstock particulate constituents and no impurity phases were detected even after 6 hours of trituration of the feedstock component particulate by autogrinding.

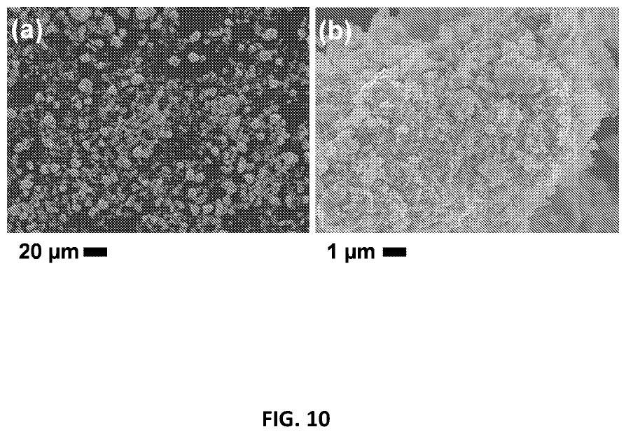

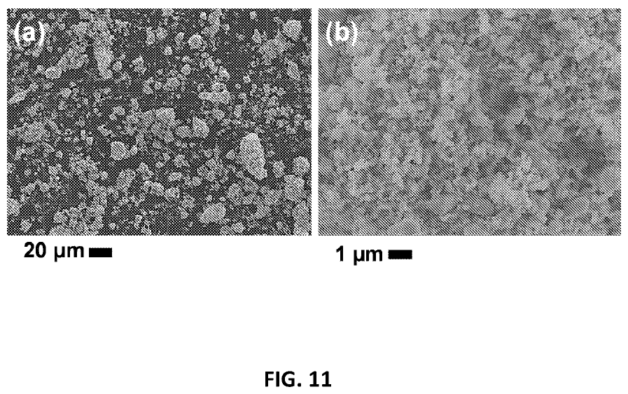

FIGS. 10 and 11 show SEM images of the feedstock particulate mixtures prepared after triturating the feedstock component particulate of Examples 1 and 2 respectively. The feedstock particulate mixtures are composed of small primary particles that have average sizes that are less than 1 μm and that are loosely agglomerated into larger secondary particles, that are about 5-20 μm in size.

FIG. 7 shows XRD patterns of the RS-precursor particulates of Examples 1 and 2, which are characteristic of a phase pure rock-salt structure with lattice constants of 4.241 Å for Example 1 and 4.243 Å for Example 2. The apparent lattice strain was determined by the Williamson-Hall method to be 0.127% for Example 1 and 0.179% for Example 2, indicating excellent compositional homogeneity in these samples.

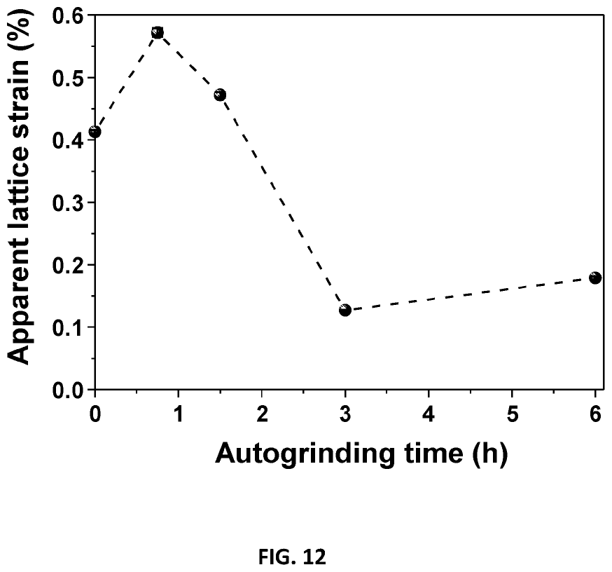

FIG. 12 plots the apparent lattice strain of the RS-precursor particulate of Comparative Examples 1 and 2 and of Examples 1 and 2 as a function of the feedstock component particulate trituration time in their preparation. According to this figure, a trituration time of more than 1.5 hours is needed under the trituration conditions used to achieve a desired apparent lattice strain value that is less than 0.3%, corresponding to good compositional homogeneity in the resulting RS-precursor particulate.

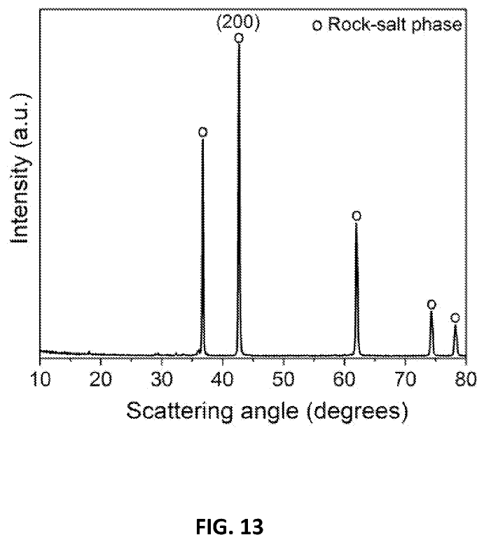

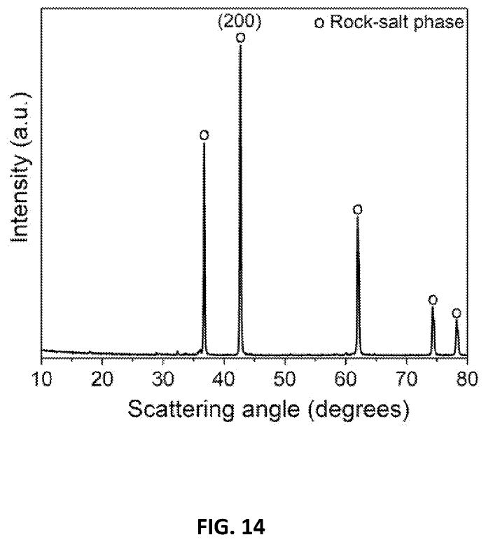

FIGS. 13 and 14 show XRD patterns of the RS-precursor particulates of Examples 3 and 4, which are characteristic of a phase pure rock-salt structure with lattice constants of 4.234 Å for Example 3 and 4.231 Å for Example 4. The apparent lattice strain was determined by the Williamson-Hall method to be 0.088% for Example 3 and 0.079% for Example 4, indicating excellent compositional homogeneity in these samples.

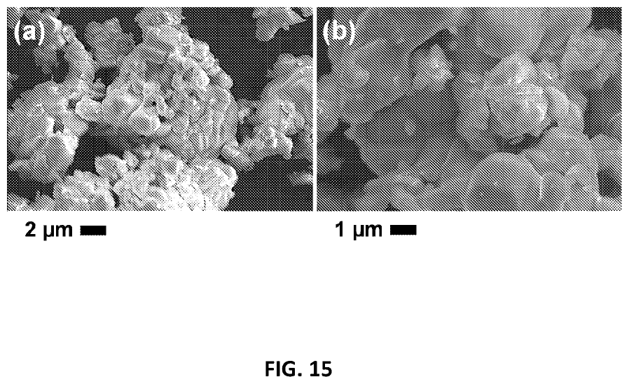

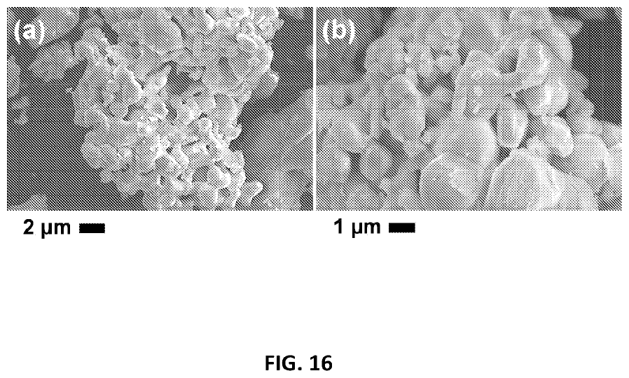

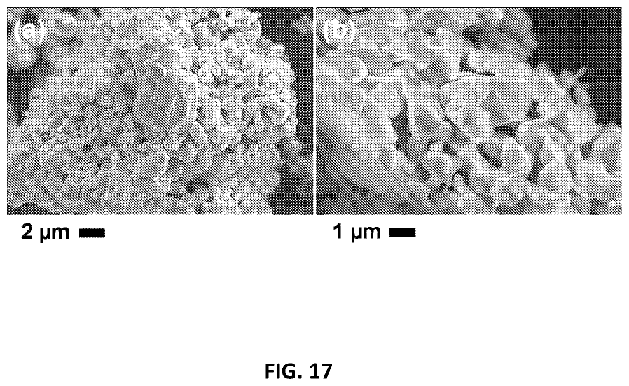

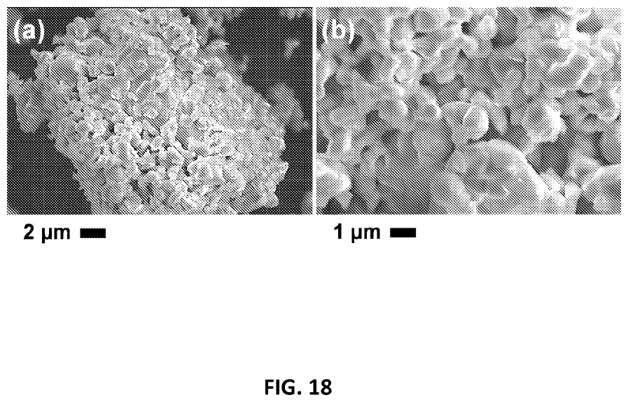

FIGS. 15-18 show SEM images of the RS-precursor particulates of Examples 1-4, respectively. All the samples consist of faceted primary crystallites. The average grain size of the RS-precursor particulates of Examples 1-4 are listed in Table 2.

TABLE 1

| | Autogrinding | Heating | | | Apparent |
|---|---|---|---|---|---|
| | Trituration | Temper- | Heating | Lattice | Lattice |
| | Time | ature | Time | Constant | Strain |
| Example | (hours) | (° C.) | (hours) | (Å) | (%) |
| Comparative | 0 (hand | 1000 | 12 | 4.234 | 0.413 ± 0.002 |
| Example 1 | ground) | | | | |
| Comparative | 0.75 | 1000 | 12 | 4.237 | 0.572 ± 0.007 |
| Example 2 | | | | | |
| Comparative | 1.5 | 1000 | 12 | 4.239 | 0.472 ± 0.004 |
| Example 3 | | | | | |
| Example 1 | 3 | 1000 | 12 | 4.241 | 0.127 ± 0.001 |
| Example 2 | 6 | 1000 | 12 | 4.243 | 0.179 ± 0.002 |
| Example 3 | 3 | 940 | 12 | 4.234 | 0.088 ± 0.001 |
| Example 4 | 3 | 900 | 12 | 4.231 | 0.079 ± 0.001 |

TABLE 2
Average grain size of the RS-precursor particulates of Examples 1-4.

| | Grain size |
|---|---|
| | (as determined by SEM) |
| Example | (μm) |
| Example 1 | 1.73 ± 0.74 |
| Example 2 | 1.55 ± 0.53 |
| Example 3 | 1.23 ± 0.33 |
| Example 4 | 0.83 ± 0.20 |

### Comparative Example 4

SC-LiNMC Made with 25% Excess Li Using a Li₂CO₃ Lithium Source

SC-LiNMC was prepared as follows. 2 g of the RS-precursor particulate of Comparative Example 1 was ground for 10 minutes by mortar and pestle with 1.25 g of Li₂CO₃ (Alfa Aesar, 99%), corresponding to 25% excess lithium content, according to the Li:Ni:Mn:Co ratio given by the formula LiNi_{0.6}Mn_{0.2}Co_{0.2}O₂. The resulting RS-precursor particulate lithium source mixture was placed in an alumina crucible and heated in a tube furnace in air for 3 hours at 800° C. and then 6 hours at 900° C. (these heatings at 800° C. and 900° C. constituting the LiNMC forming heating procedure). Finally, the SC-LiNMC product was ground with a mortar and pestle and passed through a 38 μm sieve.

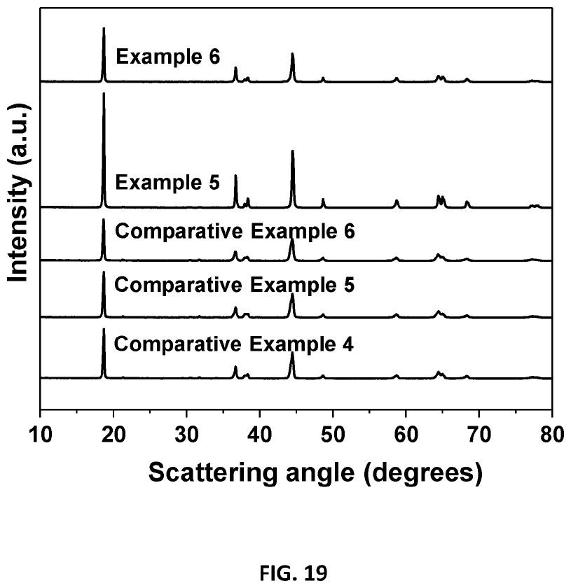

An XRD pattern of the SC-LiNMC of Comparative Example 4 is shown in FIG. 19. It is characteristic of single phase LiNi_{0.6}Mn_{0.2}Co_{0.2}O₂ with the α-NaFeO₂ structure.

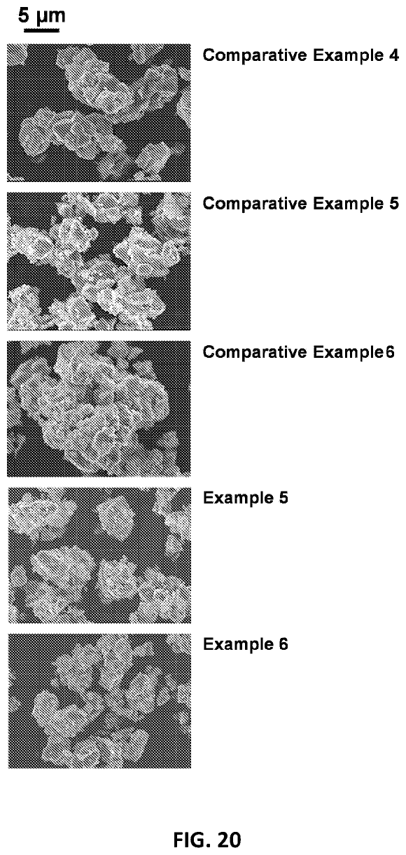

A SEM image of the SC-LiNMC of Comparative Example 4 is shown in FIG. 20. It consists of single crystal grains with an average size of about 3 μm aggregated together into secondary particles that are about 15 μm in size.

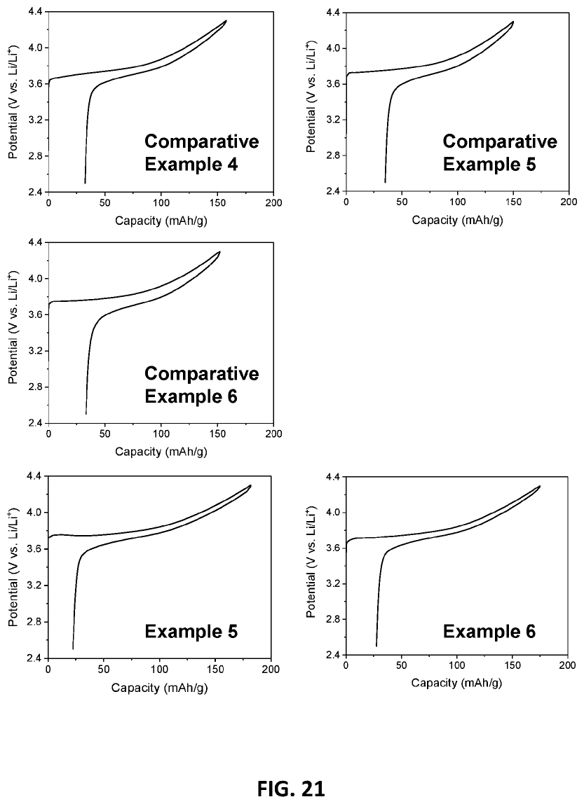

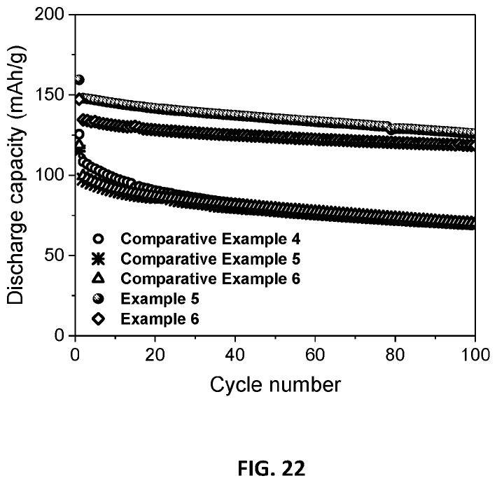

An electrode and electrochemical test cell were made from the SC-LiNMC of Comparative Example 4. The first cycle voltage curve of this cell is shown in FIG. 21 and the discharge capacity as a function of cycle number are shown in FIG. 22. The reversible capacity, initial coulombic efficiency, and percent fade after 100 cycles of the test cell is listed in Table 3. The SC-LiNMC had relatively low capacity and initial coulombic efficiency for its composition. In addition, it had a high fade rate. This is thought to be directly related to the inhomogeneity in the precursor particulate used in the synthesis of this SC-LiNMC, which lead to inhomogeneity in the final SC-LiNMC particulate.

TABLE 3
First cycle reversible capacity, initial coulombic efficiency (ICE)
and percent capacity fade after 100 cycles of electrochemical
test cells made with electrodes utilizing Comparative Example 4,
Comparative Example 5, Comparative Example 6, Example 5, and
Example 6 as their active material.

| | Reversible | | |
|---|---|---|---|
| | Capacity | ICE | Fade |
| Example | (mAh/g) | (%) | (%) |
| Comparative | 126 | 80 | 45 |
| Example 4 | | | |
| Comparative | 115 | 77 | 39 |
| Example 5 | | | |
| Comparative | 119 | 78 | 41 |
| Example 6 | | | |
| Example 5 | 159 | 88 | 21 |
| Example 6 | 147 | 84 | 19 |

### Comparative Examples 5 and 6

SC-LiNMC Made with 25% Excess Li Using a Li₂CO₃ Lithium Source

SC-LiNMC was prepared in the same manner as Comparative Example 4, excepting that instead of using RS-precursor particulate of Comparative Example 1, RS-precursor particulate of Comparative Example 2 and Comparative Example 3 were utilized, respectively.

XRD patterns of the SC-LiNMC of Comparative Example 5 and Comparative Example 6 are shown in FIG. 19. They are characteristic of single phase LiNi_{0.6}Mn_{0.2}Co_{0.2}O₂ with the α-NaFeO₂ structure.

SEM images of the SC-LiNMC of Comparative Example 5 and Comparative Example 6 are shown in FIG. 20. They consist of single crystal grains with an average size of about 3 μm aggregated together into secondary particles that are about 15 μm in size.

Electrode and electrochemical test cells were made from the SC-LiNMC particulate of Comparative Example 5 and Comparative Example 6. Their first cycle voltage curves are shown in FIG. 21 and their discharge capacities as a function of cycle number are shown in FIG. 22. The reversible capacity, initial coulombic efficiency, and percent fade after 100 cycles of these test cells are listed in Table 3. These samples of SC-LiNMC had relatively low capacity and low initial coulombic efficiency for their composition. In addition, they had a high fade rate. This is thought to be directly related to the inhomogeneity in the precursor particulate used in the synthesis of the SC-LiNMC of Comparative Examples 5 and 6, which lead to inhomogeneity in the final SC-LiNMC particulate.

### Examples 5 and 6

SC-LiNMC Made with 25% Excess Li Using a Li₂CO₃ Lithium Source

SC-LiNMC was prepared in the same manner as Comparative Example 4, excepting that instead of using RS-precursor particulate of Comparative Example 1, RS-precursor particulate of Examples 1 and 2 were utilized, respectively.

XRD patterns of the SC-LiNMC of Examples 5 and 6 are shown in FIG. 19. They are characteristic of single phase LiNi_{0.6} Mn_{0.2}Co_{0.2}O₂ with the α-NaFeO₂ structure.

SEM images of the SC-LiNMC of Examples 5 and 6 are shown in FIG. 20. They consist of single crystal grains with an average size of about 3 μm aggregated together into secondary particles that are about 15 μm in size.

Electrode and electrochemical test cells were made from the SC-LiNMC particulate of Examples 5 and 6. Their first cycle voltage curves are shown in FIG. 21 and their discharge capacities as a function of cycle number are shown in FIG. 22. The reversible capacity, initial coulombic efficiency, and percent fade after 100 cycles of these test cells are listed in Table 3. These samples of SC-LiNMC had high capacity and high initial coulombic efficiency for their composition. In addition, they had a low fade rate. This is thought to be directly related to the homogeneity in composition of the precursor particulate used in the synthesis of the SC-LiNMC of Examples 5 and 6, which lead to homogeneity in the final SC-LiNMC particulate.

Example 7

SC-LiNMC Made with 5% Excess Li Using a Li₂CO₃ Lithium Source

SC-LiNMC was prepared the same way as described in Example 6, except that 1.05 g of Li₂CO₃ (Alfa Aesar, 99%) was used, corresponding to 5% excess lithium content, according to the Li:Ni:Mn:Co ratio given by the formula LiNi_{0.6}Mn_{0.2}Co_{0.2}O₂.

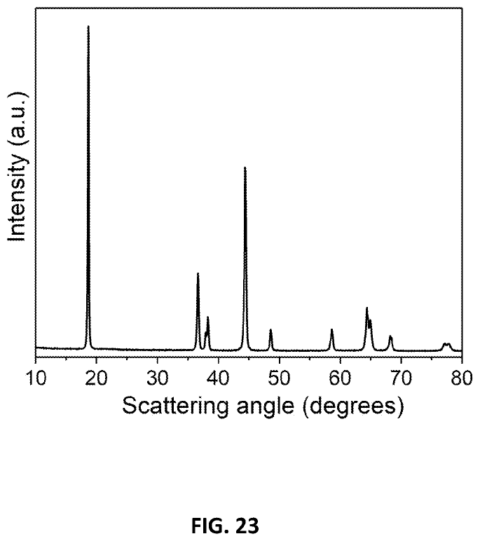

An XRD pattern of the SC-LiNMC of Example 7 is shown in FIG. 23. It is characteristic of single phase LiNi_{0.6}Mn_{0.2}Co_{0.2}O₂ with the α-NaFeO₂ structure.

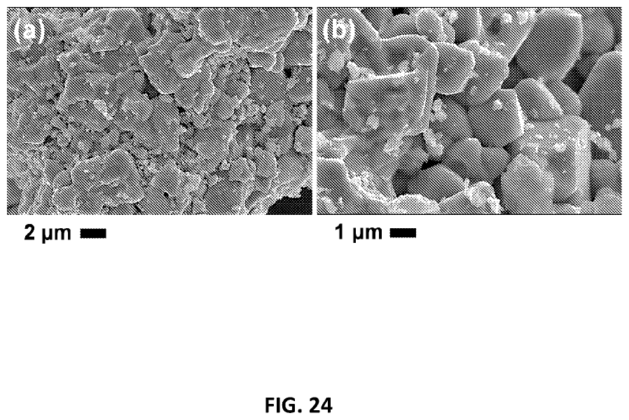

SEM images of the SC-LiNMC of Example 7 are shown in FIG. 24. It consists of single crystal grains aggregated together. The average grain size was 1.7±0.5 μm, as determined from SEM images.

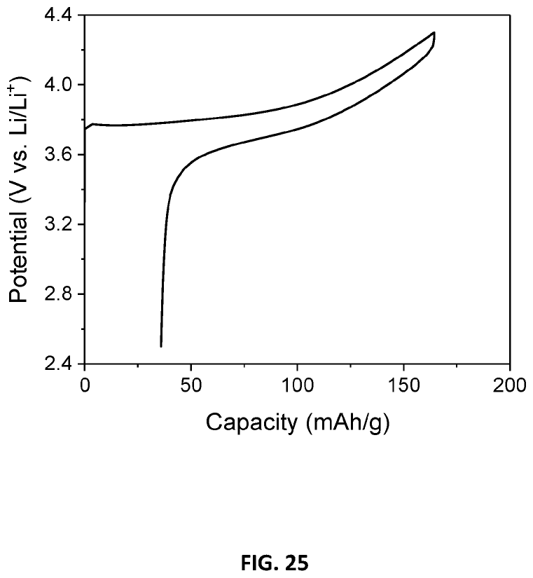

An electrode and cell were made from the SC-LiNMC of Example 7 and the first cycle voltage curve of this cell is shown in FIG. 25. This sample had a first cycle reversible capacity (RC) of 159 mAh/g and an ICE of 88%.

Without being bound by theory, it is believed that the higher ICE of the SC-LiNMC cell of Example 5 compared to Example 7 is due to a larger amount of excess lithium source used in Example 5. In Example 7, it is suspected that not enough lithium was present to fully lithiate the sample due to Li₂O₂ evaporation during the heating step to form LiNMC. The larger amount of excess lithium source used in Example 5 resulted in a more complete lithiation of the sample, leading to its observed higher ICE.

### Example 8

SC-LiNMC Made with 5% Excess Li Using a Li₂CO₃ Lithium Source and with Increased Lithium Partial Pressure During the Heating Step to Form SC-LiNMC

SC-LiNMC was prepared the same way as described in Example 7, except that an alumina crucible filled with pure Li₂O powder was placed upstream in the flow of air from the sample during the heating step to form LiNMC.

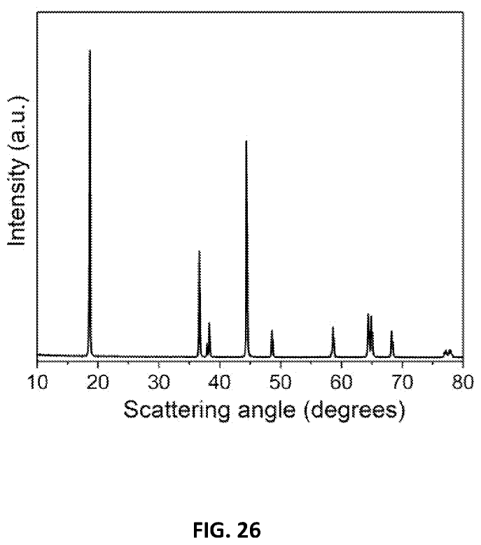

An XRD pattern of the SC-LiNMC of Example 8 is shown in FIG. 26. It is characteristic of single phase LiNi_{0.6}Mn_{0.2}Co_{0.2}O₂ with the α-NaFeO₂ structure.

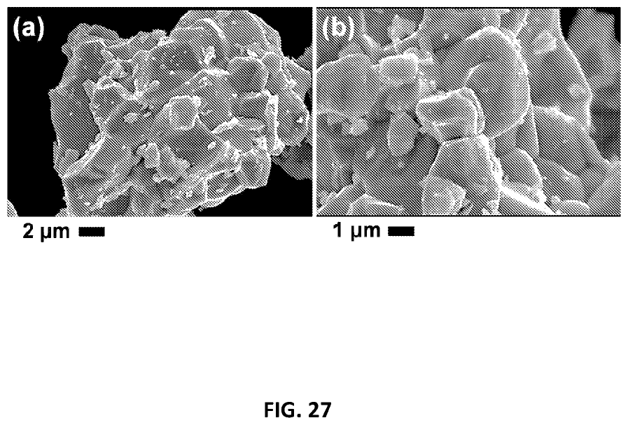

SEM images of the SC-LiNMC of Example 8 are shown in FIG. 27. It consists of single crystal grains aggregated together. The average grain size was 3.55±1.07 μm, as determined from SEM images.

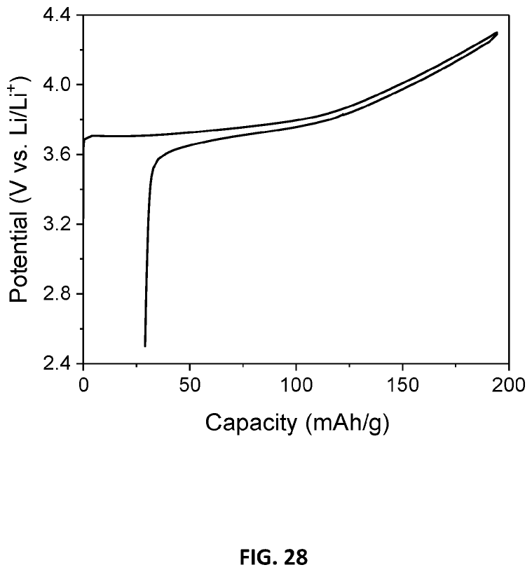

An electrode and cell were made from the SC-LiNMC of Example 8 and the first cycle voltage curve is shown in FIG. 28. This sample had a first cycle reversible capacity of 164 mAh/g and an ICE of 85%.

Without being bound by theory, it is believed that the larger grain size, higher RC, and higher ICE of the SC-LiNMC particulate of Example 8 compared to Example 7 is due to a decrease in the amount of lithium lost due to Li₂O₂ evaporation because of increased lithium partial pressure during the heating step to form NMC due the presence of Li₂O during this heating step. In Example 7, it is suspected that not enough lithium was present to fully lithiate the sample due to Li₂O₂ evaporation during the heating process. In Example 8, it is believed that a larger amount of excess lithium source is available during the heating step to form NMC because of decreased lithium loss from Li₂O₂ evaporation, resulting in a more complete lithiation of the SC-LiNMC.

### Example 9

SC-LiNMC Made with 5% Excess Li Using a Li₂O Lithium Source

SC-LiNMC was prepared the same way as described in Example 8, except that 0.42 g of Li₂O (Alfa Aesar, 99%), corresponding to 5% excess lithium content, was used as the lithium source.

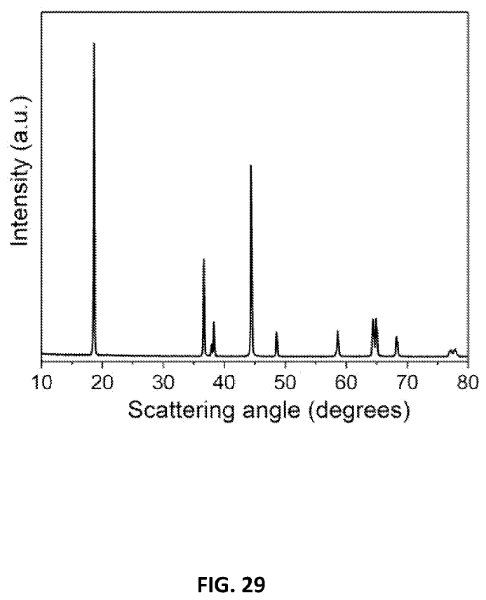

An XRD pattern of the SC-LiNMC of Example 9 is shown in FIG. 29. It is characteristic of single phase LiNi_{0.6}Mn_{0.2}Co_{0.2}O₂ with the α-NaFeO₂ structure.

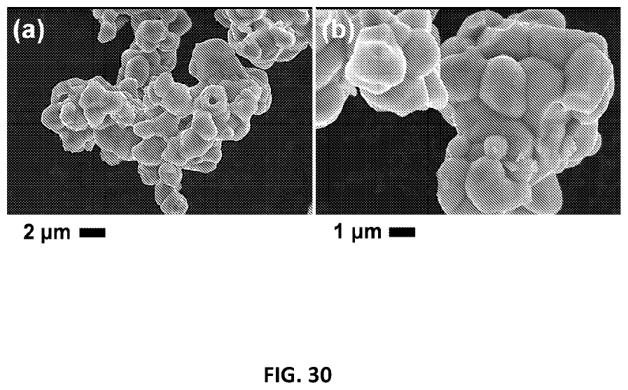

SEM images of the SC-LiNMC of Example 9 are shown in FIG. 30. It consists of single crystal grains aggregated together. The average grain size was 1.73±0.63 μm, as determined from SEM images.

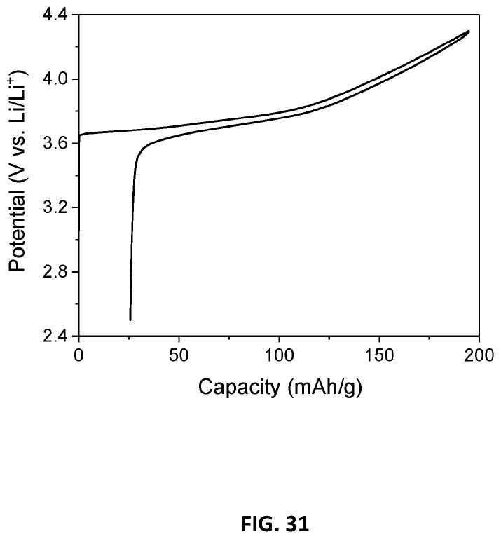

An electrode and cell were made from the SC-LiNMC of Example 9 and the first cycle voltage curve is shown in FIG. 31. This sample had a first cycle reversible capacity of 169 mAh/g and an ICE of 87%.

Without being bound by theory, it is believed that the higher RC and higher ICE of Example 9 compared to Example 7 is due to a decrease in the amount of lithium lost due to Li₂O₂ evaporation because Li₂O was used as the lithium source instead of Li₂CO₃. In Example 7, it is suspected that not enough lithium was present to fully lithiate the sample due to Li₂O₂ evaporation during the heating process. In Example 9, it is believed that a larger amount of excess lithium source is available during the heating step to form LiNMC because of decreased lithium loss from Li₂O₂ evaporation. It is further believed that this resulted in a more complete lithiation of the SC-LiNMC of Example 9, leading its observed higher RC and higher ICE compared to the SC-LiNMC of Example 7.

### Example 10

SC-LiNMC Made with 5% Excess Li Using a Li₂CO₃ Lithium Source

SC-LiNMC was prepared as follows. 2 g of the RS precursor particulate of Example 1 was ground for 10 minutes by mortar and pestle with 1.05 g of Li₂CO₃ (Alfa Aesar, 99%), corresponding to 5% excess lithium content, according to the Li:Ni:Mn:Co ratio given by the formula LiNi_{0.6}Mn_{0.2}Co_{0.2}O₂. The resulting precursor particulate lithium source mixture was placed in an alumina crucible and heated in a tube furnace in air for 12 hours at 900° C. (this heating at 900° C. constituting the LiNMC forming heating procedure). Finally, the SC-LiNMC product was ground with a mortar and pestle and passed through a 38 μm sieve.

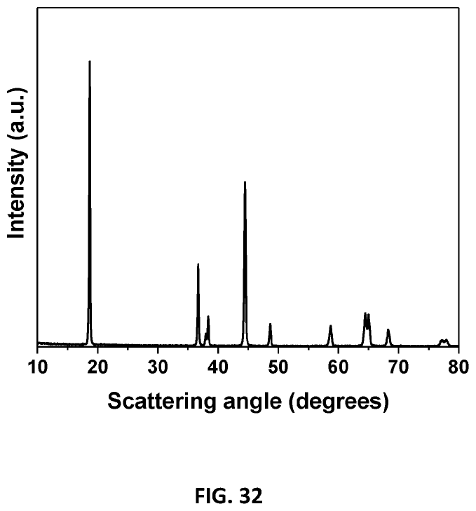

An XRD pattern of the SC-LiNMC of Example 10 is shown in FIG. 32. It is characteristic of single phase LiNi_{0.6}Mn_{0.2}Co_{0.2}O₂ with the α-NaFeO₂ structure.

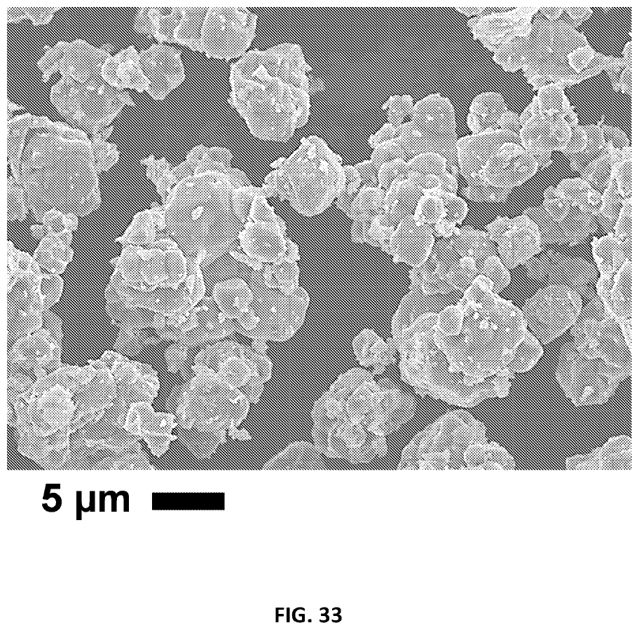

A SEM image of the SC-LiNMC of Example 10 is shown in FIG. 33. It consists of single crystal grains aggregated together. The average grain size was 3.8±1.2 μm, as determined from SEM images.

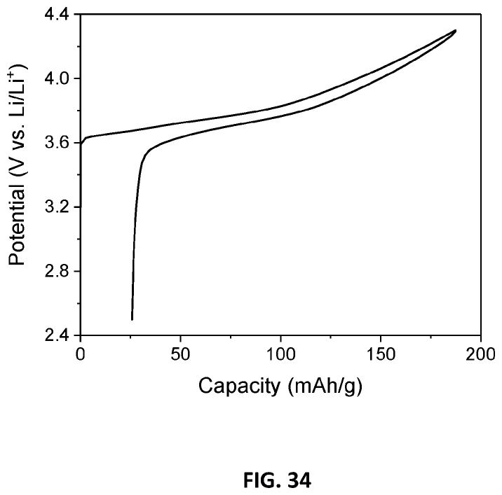

An electrode and cell were made from the SC-LiNMC of Example 10 and the first cycle voltage curve of this cell is shown in FIG. 34. This sample had a first cycle reversible capacity (RC) of 161.6 mAh/g and an ICE of 86.2%.

### Example 11

### Biphasic Precursor Particulate

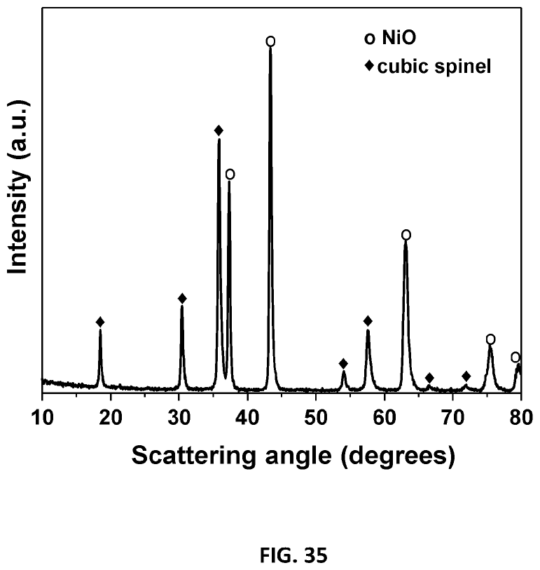

A RS-precursor particulate having the chemical formula LiNi_{0.6}Mn_{0.2}Co_{0.2}O was prepared using the same method as Example 1. This RS-precursor particulate was then placed in an alumina crucible and heated in the air for 5 hours at 700° C. An XRD pattern of the resulting biphasic precursor particulate is shown in FIG. 35. The XRD pattern is characteristic of a phase having the rock-salt structure co-existing with a phase having the cubic spinel structure. The phase having the rock-salt structure has a lattice constant of 4.172 Å, consistent with NiO. Therefore, this phase is believed to be NiO or MO, where M is a combination of Ni plus a small amount of Mn and/or Co. The grain size of the phase having the rock-salt structure is 205 Å according to the result of applying the Scherrer equation to its largest XRD peak. The phase having the cubic spinel structure has a lattice constant of 8.2883 Å and is believed to have the formula M′₃O₄ where M′ is a combination of Mn, Co, and possibly Ni, for example (Mn_{0.5}Co_{0.5})₃O₄. The grain size of the phase having the cubic spinel structure is 250 Å according to the result of applying the Scherrer equation to its largest XRD peak.

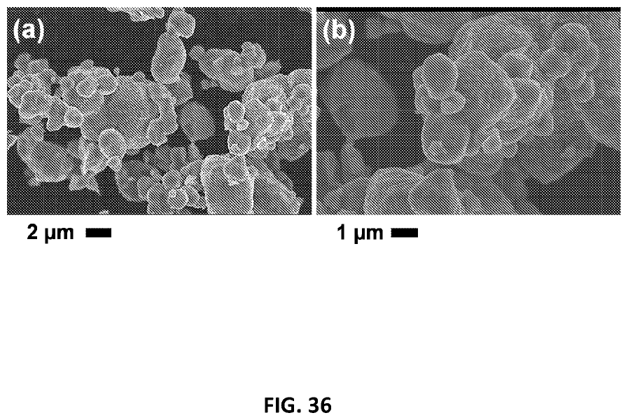

A SEM image of the biphasic precursor particulate of Example 12 is shown in FIG. 36. It consists of primary particulates that are 2-8 μm in size. This is a completely different morphology compared to RS-precursor particulate of Example 1, in which most primary particles are submicron in size. Without being bound to theory, it is believed that the conversion of the RS-precursor particulate to a biphasic precursor particulate includes the fusion of multiple primary particles, further improving the homogeneity of the precursor particulate.

### Example 12

SC-LiNMC Made From a Biphasic Precursor Particulate and 5% Excess Li Using a Li₂CO₃ Lithium Source

SC-LiNMC was prepared as follows. 2 g of the biphasic precursor particulate of Example 11 was ground for 10 minutes by mortar and pestle with 1.05 g of Li₂CO₃ (Alfa Aesar, 99%), corresponding to 5% excess lithium content, according to the Li:Ni:Mn:Co ratio given by the formula LiNi_{0.6}Mn_{0.2}Co_{0.2}O₂. The resulting precursor particulate lithium source mixture was placed in an alumina crucible and heated in a tube furnace in air for 12 hours at 900° C. (this heating at 900° C. constituting the LiNMC forming heating procedure). Finally, the SC-LiNMC product was ground with a mortar and pestle and passed through a 38 μm sieve.

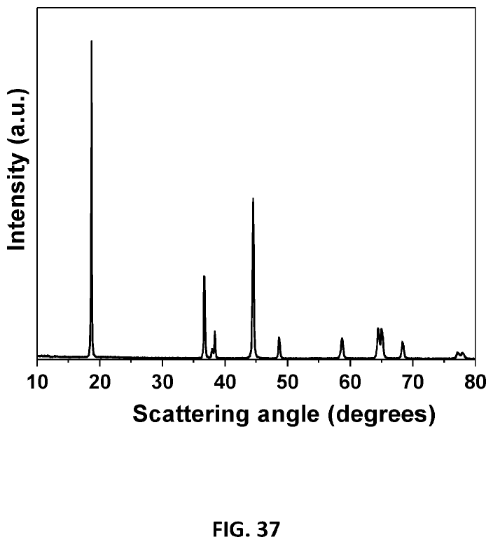

An XRD pattern of the SC-LiNMC of Example 12 is shown in FIG. 37. It is characteristic of single phase LiNi_{0.6}Mn_{0.2}Co_{0.2}O₂with the α-NaFeO₂ structure.

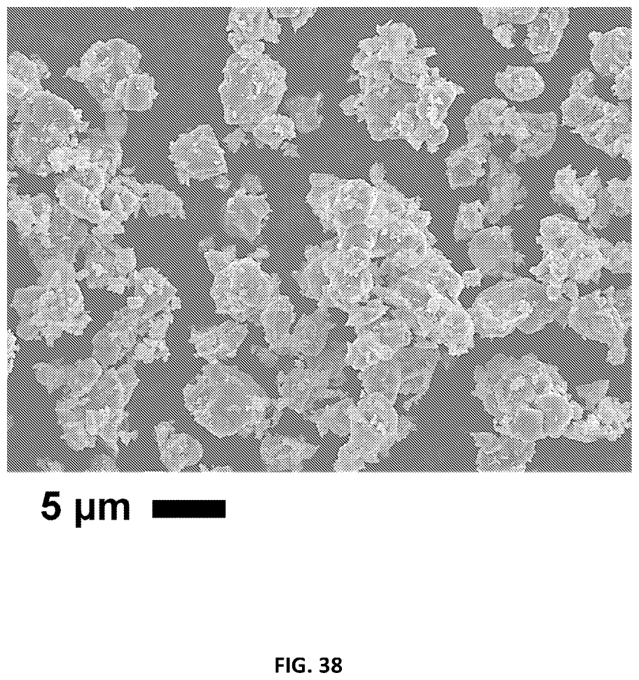

A SEM image of the SC-LiNMC of Example 12 is shown in FIG. 38. It consists of single crystal grains aggregated together. The average grain size was 2.6±0.7 μm, as determined from SEM images.

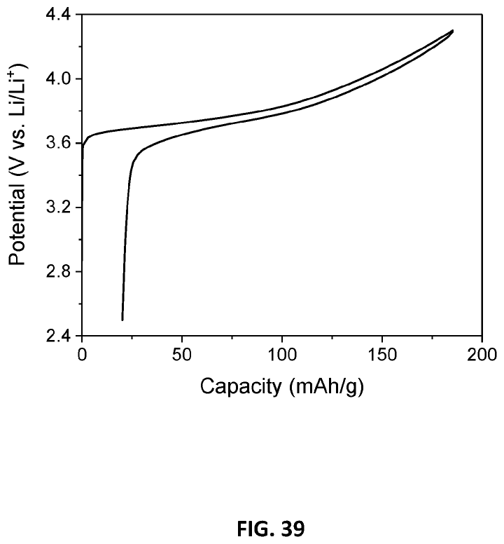

An electrode and an electrochemical test cell were made from the SC-LiNMC of Example 12 and the first cycle voltage curve is shown in FIG. 39. This sample had a first cycle reversible capacity of 165.2 mAh/g and an ICE of 89.1%.

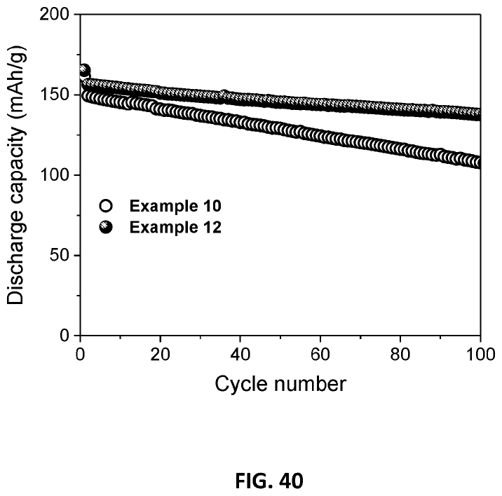

The capacity vs. cycle number of the cells for the Examples 10 and 12 is plotted in FIG. 40. The cells for the Examples 10 and 12 had 33.2% and 16.7% capacity fade over 100 cycles, respectively. The higher reversible capacity, ICE, and capacity retention of the SC-LiNMC of Example 12 compared to Example 10 is thought to be due to the greater ease of lithiation of the biphasic precursor particulate used to make the SC-LiNMC of Example 12 compared to the RS-precursor particulate used to make the SC-LiNMC of Example 10.

### Example 13

### RS-Precursor Particulates Made From Hydroxide Feedstock Component Particulates

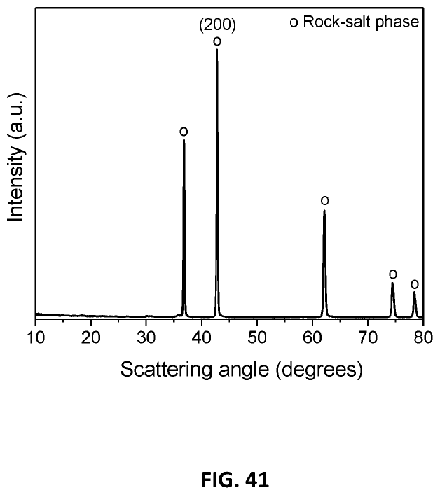

RS-precursor particulate Example 13 having the chemical formula LiNi_{0.6}Mn_{0.2}Co_{0.2}O was prepared by triturating 3.02 g Ni(OH)₂ powder (Sigma-Aldrich, −325 mesh, 99%), 0.97 g Mn(OH)₂ powder (City Chemical LLC, −60 mesh, 99%), and 1.01 g Co(OH)₂ powder (Alfa Aesar, 99.7%) using an autogrinder (Pulverisette 2 Mortar Grinder, Fritsch GmbH) for 3 h. The resulting mixture was placed in an alumina crucible and heated in a tube furnace for 12 hours at 1000° C. under an argon flow. An alumina crucible filled with MnO powder was placed upstream in the furnace tube as an oxygen getter. The resulting RS-precursor particulate was ground in a mortar and pestle and passed through a 53 μm sieve. FIG. 41 shows the XRD pattern of the resulting RS-precursor particulate, which is characteristic of a phase pure rock-salt structure with a lattice constant of 4.225 Å. The apparent lattice strain was determined by the Williamson-Hall method to be 0.146%, indicating excellent compositional homogeneity in this sample.

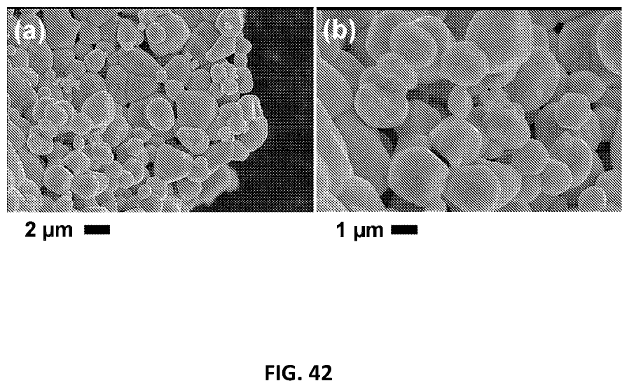

FIGS. 42a and b show SEM images of the RS-precursor particulates of Examples 13. The sample consists of faceted primary crystallites. The average grain size was 1.5±0.5 μm, as determined from SEM images.

### Comparative Example 7

### RS-precursor Particulates Made From Cold-Pressed Oxide Feedstock Component Particulates

RS-precursor particulate Comparative Example 7 having the chemical formula LiNi0.6Mn0.2Co0.2O was prepared by triturating 3.03 g NiO (Sigma-Aldrich, −325 mesh, 99%), 0.96 g MnO (Aldrich, −60 mesh, 99%), and 1.01 g CoO (Alfa Aesar, 99.7%) feedstock particulates by hand grinding in a mortar and pestle. The resulting mixture was pressed into pellets at pressures of ˜56 kg/mm2 using a hardened steel die. The resulting cylindrical pellets with 15 mm in diameter and ˜2-3 mm in height were then placed in an alumina crucible and heated in a tube furnace for 12 hours at 1000° C. under an argon flow. An alumina crucible filled with MnO powder was placed upstream in the furnace tube as an oxygen getter. The resulting RS-precursor particulate was ground in a mortar and pestle and passed through a 53 μm sieve.

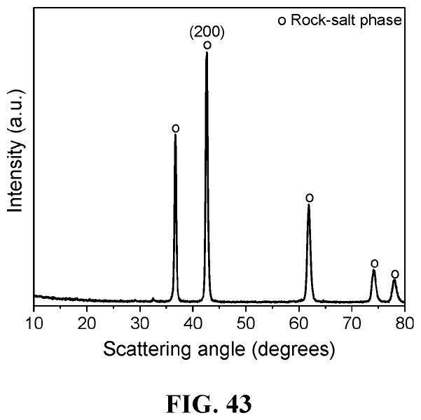

FIG. 43 shows the XRD pattern of the resulting RS-precursor particulate, which is characteristic of a phase pure rock-salt structure with a lattice constant of 4.241 Å. The apparent lattice strain was determined by the Williamson-Hall method to be 0.398%, which is lower than RS-precursor particulate Comparative Example 1 (i.e., 0.413%) but exceeds an apparent lattice strain value of 0.3%, indicating poor compositional homogeneity in this sample, which is believed to be due to an insufficient trituration step.

Example 14

RS-Precursor Particulates Made From Cold-Pressed Oxide Feedstock Component Particulates and Na₂SO₄ Flux

RS-precursor particulate Example 14 having the chemical formula LiNi_{0.6}Mn_{0.2}Co_{0.2}O was prepared utilizing the same method as Comparative Example 7, excepting that a Na₂SO₄ flux was used in its preparation, which was removed by washing after the feedstock particulate mixture was heated. Specifically, RS-precursor particulate Example 14 was prepared by triturating 3.03 g NiO (Sigma-Aldrich, −325 mesh, 99%), 0.96 g MnO (Aldrich, −60 mesh, 99%), 1.01 g CoO (Alfa Aesar, 99.7%) feedstock particulates and 2.5 g Na₂SO₄ (Fisher Scientific, Anhydrous, 99%) as a flux (feedstock particulates/flux ratio=2) by hand grinding in a mortar and pestle. The resulting mixture was pressed into pellets at pressures of ˜56 kg/mm² using a hardened steel die. The resulting cylindrical pellets with 15 mm in diameter and ˜2-3 mm in height were then placed in an alumina crucible and heated in a tube furnace for 12 hours at 1000° C. under an argon flow. An alumina crucible filled with MnO powder was placed upstream in the furnace tube as an oxygen getter. The resulting particulate after grinding in a mortar and pestle was separated from the remaining flux by washing with distilled water and then heated for 24 hours at 120° C. in air. The resulting RS-precursor particulate was ground in a mortar and pestle and passed through a 53 μm sieve.

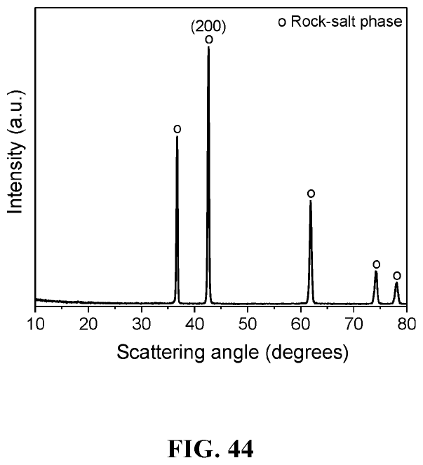

FIG. 44 shows the XRD pattern of the resulting RS-precursor particulate, which is characteristic of a phase pure rock-salt structure with a lattice constant of 4.242 Å. The apparent lattice strain was determined by the Williamson-Hall method to be 0.246%, indicating excellent compositional homogeneity in this sample. This is in contrast to Comparative Example 7, which was prepared in the same way, excepting in that comparative example a flux was not used, which resulted in a higher apparent lattice strain value of 0.413%.

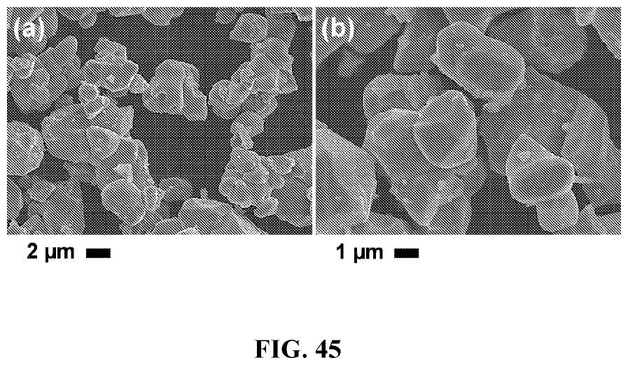

FIGS. 45a and b show SEM images of the RS-precursor particulates of Examples 15. The sample consists of faceted primary crystallites. The average grain size was 2.2±0.8 μm, as determined from SEM images.

Example 15

RS-Precursor Particulates Made From Cold-Pressed Oxide Feedstock Component Particulates and MoO₃ flux

RS-precursor particulate Example 15 having the chemical formula LiNi_{0.6}Mn_{0.2}Co_{0.2}O was prepared utilizing the same method as Comparative Example 7, excepting that a MoO₃ flux was used in its preparation. Specifically, RS-precursor particulate Example 15 was prepared by triturating 3.03 g NiO (Sigma-Aldrich, −325 mesh, 99%), 0.96 g MnO (Aldrich, −60 mesh, 99%), 1.01 g CoO (Alfa Aesar, 99.7%) feedstock particulates and 0.2 g MoO₃ (Alfa Aesar, 99.5%) as a flux (feedstock particulates/flux ratio=25) by hand grinding in a mortar and pestle. The resulting mixture was pressed into pellets at pressures of ˜56 kg/mm² using a hardened steel die. The resulting cylindrical pellets with 15 mm in diameter and ˜2-3 mm in height were then placed in an alumina crucible and heated in a tube furnace for 12 hours at 1000° C. under an argon flow. An alumina crucible filled with MnO powder was placed upstream in the furnace tube as an oxygen getter. The resulting particulate was ground in a mortar and pestle and passed through a 53 μm sieve.

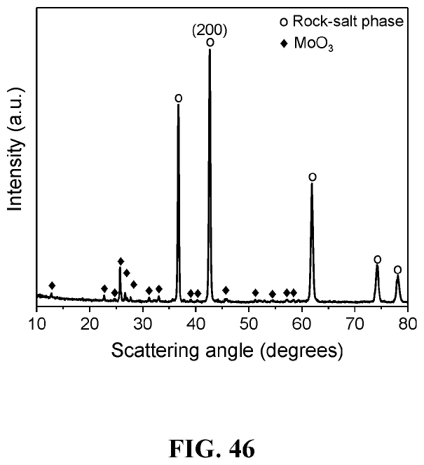

FIG. 46 shows the XRD pattern of the resulting precursor particulate, which is characteristic of a phase rock-salt structure with a lattice constant of 4.240 Å co-existing with MoO₃ flux. The apparent lattice strain for rock-salt phase was determined by the Williamson-Hall method to be 0.242%, indicating excellent compositional homogeneity in this sample. This is in contrast to Comparative Example 7, which was prepared in the same way, excepting in that comparative example a flux was not used, which resulted in a higher apparent lattice strain value of 0.413%.

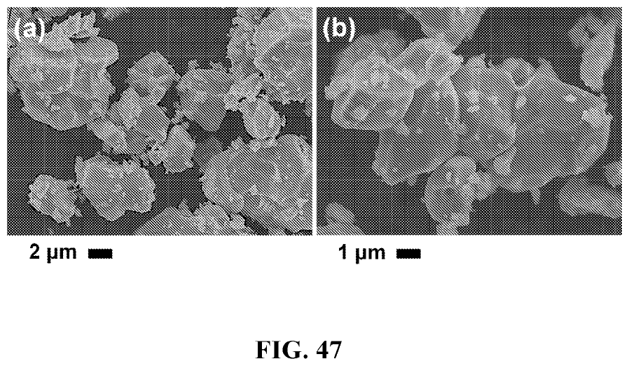

FIGS. 47a and b show SEM images of the RS-precursor particulates of Examples 16. The average grain size was 3.5+1.3 μm. as determined from SEM images.

The preceding examples demonstrate that precursor particulate in the form of a single-phase RS-precursor particulate with high compositional homogeneity, as indicated by an apparent lattice strain of less than 0.3%, may be synthesized by a method that includes trituration of feedstock component particulate and subsequent heating of the resulting precursor particulate mixture. The RS-precursor particulate may be transformed to a biphasic precursor particulate by a heating step in air. The preceding examples further demonstrate that RS-precursor particulate with high compositional homogeneity, as indicated by an apparent lattice strain of less than 0.3%, are useful for the synthesis of LiNMC and SC-LiNMC with desirable electrochemical properties of low voltage polarization, low capacity fade, and high initial coulombic efficiency. Even superior electrochemical properties can be achieved when RS-precursor particulate with exceptionally high compositional homogeneity, as indicated by an apparent lattice strain of less than 0.2% or even lower, is utilized for the synthesis of LiNMC. It has been further demonstrated that LiNMC with even superior electrochemical properties may be formed utilizing a biphasic particulate formed from a RS-precursor particulate with high compositional homogeneity, as indicated by an apparent lattice strain of less than 0.3%. Conversely, LiNMC synthesized from RS-precursor particulate with low compositional homogeneity, as indicated by an apparent lattice strain of more than 0.3%, has undesirable electrochemical properties of high voltage polarization, high capacity fade, and low initial coulombic efficiency.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A method of preparing a lithium nickel manganese cobalt oxide particulate having a formula Li₁₊ₓ[(NiₙMnₘCo_{c})₁₋ₐAₐ]₁₋ₓO₂, wherein −0.03≤x≤0.06; n+m+c =1; n≥0.05; m≥0.05; c≥0.05; A is a metal dopant; and 0≤a≤0.05; the method comprising:
a) providing feedstock component particulate with an Ni:Mn:Co molar ratio of n:m:c comprising a nickel containing particulate, a manganese containing particulate, a cobalt containing particulate, and an optional dopant A;
b) triturating the feedstock component particulate to form a homogenous feedstock particulate mixture;
c) heating the homogenous feedstock particulate mixture from b) at a temperature of greater than about 500° C. for a set time of at least about 1 hour, thereby producing a precursor particulate having a rock-salt structure and the formula (NiₙMnₘCo_{c})₁₋ₐAₐO ;
d) combining an amount of the precursor particulate with an amount of a lithium source to produce a precursor particulate lithium source mixture, wherein the amount of the lithium source is greater than or equal to the stoichiometric amount required to make the lithium nickel manganese cobalt oxide particulate; and
e) heating the precursor particulate lithium source mixture from d) in an oxygen containing atmosphere at a lithiating temperature to produce the lithium nickel manganese cobalt oxide particulate.

2. The method of claim 1 wherein triturating the feedstock component particulates to form a homogenous feedstock particulate mixture comprises triturating the feedstock component particulates for an amount of time determined by:
obtaining samples from the feedstock component particulates at one or more time intervals during the triturating step;
heating the samples;
determining the structure of the heated samples via x-ray diffraction analysis; and
determining the feedstock triturating time based on the time interval that results in a heated sample having a single-phase rock-salt structure with an apparent lattice strain of less than about 0.3%.

3. The method of claim 1 wherein the nickel containing particulate, the manganese containing particulate, and the cobalt containing particulate are selected from the group consisting of metal oxides, metal hydroxides, metal carbonates and mixtures thereof.

4. The method of claim 3 wherein the nickel containing particulate, the manganese containing particulate, and the cobalt containing particulate are selected from the group consisting of NiO, MnO, and CoO.

5. The method of claim 1 wherein the feedstock component particulate includes the dopant A that is selected from the group consisting of metal oxides, metal hydroxides, metal carbonates and mixtures thereof.

6. The method of claim 1 wherein n, m, and care about 0.6, about 0.2 and about 0.2 respectively.

7. The method of claim 1 wherein a feedstock triturating apparatus for triturating in b) is a dry grinding apparatus.

8. The method of claim 1 wherein the feedstock triturating time in b) is in a range from about 10 minutes to about 6 days.

9. The method of claim 1 wherein the set temperature in c) is in a range from about 500° C. to about 1600° C.

10. The method of claim 1 wherein the set time in c) is in a range from about 1 hour to about 12 hours.

11. The method of claim 1 wherein the heating in c) is conducted under an atmosphere selected from the group consisting of an inert gas, a reduced oxygen partial pressure gas, and a vacuum.

12. The method of claim 1 wherein the lithium source is lithium carbonate, lithium hydroxide, or lithium oxide, and wherein the amount of the lithium source is between about 0 to 30% greater than the stoichiometric amount required to make the lithium nickel manganese cobalt oxide particulate.

13. (canceled)

14. (canceled)

15. (canceled)

16. The method of claim 2 wherein the x-ray diffraction analysis determines the homogeneity of the trituration mixture.

17. The method of claim 1 additionally comprising forming the precursor particulate lithium source mixture into a pellet prior to step e).

18. The method of claim 17 additionally comprising adding a flux to the feedstock component particulate or the feedstock component particulate or the precursor particulate lithium source mixture prior to step e).

19. (canceled)

20. The method of claim 2 wherein:
determining the structure of the obtained samples via x-ray diffraction analysis is to ensure the obtained samples consist essentially of the nickel containing particulate phase, the manganese containing particulate phase, the cobalt containing particulate phase, and the optional dopant A containing particulate phase.

21. The method of claim 1 additionally comprising:
before step d), heating the precursor particulate in an oxygen containing atmosphere to change the precursor particulate from a particulate having a rock-salt structure to a biphasic particulate consisting essentially of a rock-salt phase and a cubic spinel phase.

22. The method of claim 1 wherein the triturating produces the homogeneous feedstock particulate mixture consisting essentially of the nickel containing particulate phase, the manganese containing particulate phase, the cobalt containing particulate phase, and the optional dopant A containing particulate phase;
wherein no chemical reaction occurs between the nickel containing particulate phase, the manganese containing particulate phase, the cobalt containing particulate phase, and the optional dopant A containing particulate phase during triturating step b).

23. (canceled)

24. The method of claim 21 wherein each of the rock-salt phase and the spinel phase in the biphasic precursor particulate have average grain sizes greater than 100 Å.

25. A biphasic particulate having a composition (NiₙMnₘCo_{c})₁₋ₐAₐO_{1+b} where n, m, c, a are positive numbers, A is a metal dopant, and n+m+c=1; n≥0.05; m≥0.05; c≥0.05; 0≤a≤0.05; and 0<b<0.33 and consisting essentially of a rock-salt phase and a cubic spinel phase.

26. The biphasic particulate of claim 25 wherein the rock-salt phase is NiO.

27. The biphasic particulate of claim 25 wherein the cubic spinel phase has a chemical formula M₃O₄ wherein M is a mixture of Mn and Co and/or M additionally comprises Ni.

28. (canceled)

29. The biphasic particulate of claim 25 wherein the cubic spinel phase has a lattice constant in a range of 8.1 Å to 8.4 Å.

30. A particulate having a composition (NiₙMnₘCo_{c})₁₋ₐAₐO where n, m, c, a are positive numbers, A is a metal dopant, and n+m+c=1; n≥0.05; m≥0.05; c≥0.05; and 0≤a≤0.05; consisting essentially of a rock-salt phase; and having an apparent lattice strain that is less than 0.3%.
